(19) United States
(12) Patent Application Publication
(10) Pub. No.: US 2007/0255928 A1
(43) Pub. Date: Nov. 1, 2007

(54) Processor

(75) Inventor: Shinichiro Fukai, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/575,756

(22) PCT Filed: Mar. 1, 2005
(86) PCT No.: PCT/JP05/03356

§ 371 Date: Mar. 22, 2007

(30) Foreign Application Priority Data
Oct. 19, 2004 (JP) 2004-304400

(51) Int. Cl. G06F 9/34

(52) U.S. Cl. 711/220

(57) ABSTRACT

A processor which can reduce delays occurring between the memory and the register file, and operate with a high operating frequency is provided.

The processor 100 includes a register file 110 having plural registers, and a tag value generation circuit 102 which generates a tag value indicating data attributes. Each of the registers has a data field 112 for holding data, and a tag field 111 for holding a tag value. When executing a load instruction for loading data into a register of the register file 110 from the memory 14, the tag value generation circuit 102 generates a tag value in accordance with the load instruction and stores the generated tag value in the tag field 111.

### TECHNICAL FIELD

The present invention relates to a processor that can operate with a high frequency, and particularly to a processor that allows improvement of operating frequency.

### BACKGROUND ART

Conventionally, there exists a processor which, during the execution of a load instruction, performs data conversion such as bit shifting, sign extension, and zero extension on data outputted from the memory, in accordance with the attributes of data identified by the load instruction, and then stores the converted data into the register file.

FIG. 1 is a diagram showing the configuration of a conventional processor.

As shown in the diagram, a processor 10 includes an instruction deciphering circuit 11, a memory read-control circuit 12, a memory write-control circuit 13, a memory 14, an arithmetic unit 15, a data conversion circuit 20, and a register file 30. In addition, the register file 30 includes plural registers each of which is configured only of a data field 31. Furthermore, each data field 31 is managed according to a register number (Reg#0 to Reg#N).

The instruction deciphering circuit 11 outputs a signal in accordance with the deciphered instruction. For example, (a) in the case where the deciphered instruction is a load instruction, the instruction deciphering circuit 11 generates a signal characterized by the load instruction (hereafter referred to as a load instruction deciphered signal), and outputs this to the memory read-control circuit 12 and the data conversion circuit 20. (b) In the case where the deciphered instruction is an arithmetic instruction, the instruction deciphering circuit 11 generates a signal characterized by the operating instruction (hereafter referred to as an arithmetic instruction deciphered signal), and outputs this to the arithmetic unit 15 and the data conversion circuit 20. (c) In the case where the deciphered instruction is a store instruction, the instruction deciphering unit 11 generates a signal characterized by the store instruction (hereafter referred to as a store instruction deciphered signal), and outputs this to the memory write-control circuit 13.

A “load instruction” refers to an instruction for loading data from the memory.

A “store instruction” refers to an instruction for storing data into the memory.

An “arithmetic instruction” is an instruction for performing an arithmetic process.

A load instruction deciphered signal includes information such as an address, data size, and a data type which are necessary for accessing and reading data from the memory 14.

An arithmetic instruction deciphered signal includes information which identifies details of an arithmetic process. A store instruction deciphered signal includes information such as an address, data size, and a data type which are necessary for accessing and writing data into the memory 14.

The memory read-control circuit 12 outputs, in accordance with a load instruction deciphered signal outputted from the instruction deciphering circuit 11, a signal characterized by the load instruction deciphered signal (hereinafter referred to as a memory read-control signal) to the memory 14.

The memory write-control circuit 13 outputs, in accordance with a store instruction deciphered signal outputted from the instruction deciphering circuit 11, a signal characterized by the store instruction deciphered signal (hereinafter referred to as a memory write-control signal) to the memory 14.

The memory 14 stores, in accordance with the memory read-control signal outputted by the memory read-control circuit 12, data identified by the memory read-control signal into the register file 30. Furthermore, in accordance with the memory write-control signal outputted from the memory write-control circuit 13, the memory 14 reads, from the register file 30, data identified by the memory write-control signal.

Moreover, the data read from the memory 14 is stored in the register file 30 after data conversion such as bit shifting, sign extension, and zero extension is performed by the data conversion circuit 20.

In accordance with the arithmetic instruction deciphered signal outputted from the instruction deciphering circuit 11, the arithmetic unit 15 reads, from the register file 30, data identified by the arithmetic instruction deciphered signal, and performs the arithmetic process identified by the arithmetic instruction deciphered signal on the read data. Then, the data obtained through the performance of the arithmetic process is stored in the register file 30.

FIG. 2 is a diagram showing the configuration of a data conversion circuit.

As shown in the diagram, here, as an example, a data conversion circuit 20 includes an alignment unit 21, a zero extension unit 22, a sign extension unit 23, and a selector 24.

The alignment unit 21 performs an alignment processes on data outputted from the memory 14, and outputs the processed data to the zero extension unit 22 and the sign extension unit 23.

An “alignment process” refers to the aligning of a partial bit string of M-bit data (M being a positive integer) so as to align with the lowest bit, and then outputting the result. For example, in the case where a partial bit string, from the 8^{th} bit to the 15^{th} bit, of 32-bit data is inputted, a bit string which is aligned with the 0^{th} bit to the 7^{th} bit is outputted.

The zero extension unit 22 performs zero extension on the data outputted from the alignment unit 21, and outputs the processed data to the selector 24.

A “zero extension process”, in the case of extending M-bit data (M being a positive integer) to N-bit data (N being a positive integer greater than M), refers to the setting of bits, from the M−1^{th} bit to the most significant bit, to “0”, and outputting the result.

The sign extension unit 23 performs code extension on the data outputted from the alignment unit 21, and outputs the processed data to the selector 24.

A “sign extension process”, in the case of extending M-bit data (M being a positive integer) to N-bit data (N being a positive integer greater than M), refers to the setting of bits, from the M−1^{th} bit to the most significant bit, to “the value of the signed bit of the M-bit data”, and outputting the result.

The selector 24 selects, in accordance with the load instruction deciphered signal outputted from the instruction deciphering circuit 11, any one of: the data outputted from the memory 14; the data outputted from the zero extension unit 22; and the data outputted from the sign extension unit 23, and outputs the selected data to the register file 30. Patent Reference 1: Japanese Laid-Open Patent Application Number 9-269895

### DISCLOSURE OF INVENTION

### Problem that Invention is to Solve

However, with the aforementioned conventional technology, since data needs to pass through the data conversion circuit 20 during the output of data from the memory 14 to the register file 30, there is the problem that the delay occurring between the memory 14 and the register file 30 increases, and this delay becomes a drawback in the development of processors operating with a high operating frequency

As such, the present invention is conceived in view of the aforementioned problem and has as an object to provide a processor which can reduce the delay occurring between the memory and the register file, and operate with a high operating frequency.

### MEANS TO SOLVE THE PROBLEM

In order to achieve the aforementioned object, the processor in the present invention is a processor including: (a) a register file having plural registers; and (b) a generation unit which generates a tag value which indicates a data attribute, wherein (c) each of the registers has a data field which holds data, and a tag field which holds the tag value, and (d) said generation unit, when executing a load instruction for loading data from a memory to a register, generates the tag value based on the load instruction, and stores the generated tag value into the tag field of the register.

Accordingly, in the case of executing an instruction for performing an arithmetic process or a store instruction for storing data from the register file into the memory, it becomes possible to perform data conversion on the data stored in the data field, and the need to perform data conversion, such as bit shifting, sign extension, and zero extension, between the memory and the register file is eliminated.

Note that the present invention can be implemented, not only as a processor, but also as a method for controlling a processor (hereafter referred to as control method), and so on. Furthermore, the present invention can also be implemented as: an LSI in which the functions provided by the processor (hereafter referred to as processor functions) are built-in; an IP core (hereafter referred to as a processor core) which forms the processor functions in a programmable logic device such as an FPGA, CPLD and the like; a recording medium onto which the processor core is recorded; and so on.

### EFFECTS OF THE INVENTION

Therefore, with the processor in the present invention, data does not need to pass through a data conversion circuit during the output of data from the memory to the register file, and thus it is possible to provide a processor which can reduce the delay occurring between the memory and the register file, and operate with a high operating frequency.

Furthermore, since data which is larger than the size of a register assigned to one register number can be easily handled, it is also possible to provide a processor which allows improvement of data processing capacity.

### BRIEF DESCRIPTION OF DRAWINGS

FIG. 1 is a diagram showing the configuration of a conventional processor.

FIG. 2 is a diagram showing the configuration of a data conversion circuit.

FIG. 3 is a diagram showing the configuration of the processor in the first embodiment.

FIG. 4 is a diagram showing, as an example, the configuration of the register file in the first embodiment.

FIG. 5 is a diagram showing, as an example, the data structure in a register in the first embodiment.

FIG. 6A is a first diagram showing an example of data conversion in the data conversion circuit in the first embodiment.

FIG. 6B is a second diagram showing an example of data conversion in the data conversion circuit in the first embodiment.

FIG. 6C is a third diagram showing an example of data conversion in the data conversion circuit in the first embodiment.

FIG. 7 is a first diagram showing the operation of the processor in the first embodiment.

FIG. 8A is a second diagram showing the operation of the processor in the first embodiment.

FIG. 8B is a third diagram showing the operation of the processor in the first embodiment.

FIG. 8C is a fourth diagram showing the operation of the processor in the first embodiment.

FIG. 9 is a diagram showing the configuration of the processor in the second embodiment.

FIG. 10 is a diagram showing, as an example, the configuration of the register file in the second embodiment.

FIG. 11 is a first diagram showing the operation of the processor in the second embodiment.

FIG. 12A is a second diagram showing the operation of the processor in the second embodiment.

FIG. 12B is a third diagram showing the operation of the processor in the second embodiment.

FIG. 13 is a diagram showing the configuration of the processor in the third embodiment.

FIG. 14 is a diagram showing, as an example, the configuration of the arithmetic unit in the third embodiment.

FIG. 15A is a diagram showing the operation of the processor in the third embodiment.

FIG. 15B is a diagram showing the operation of the processor in the third embodiment.

FIG. 16 is a diagram showing the configuration of the processor in the fourth embodiment.

FIG. 17 is a diagram showing, as an example, the configuration of the arithmetic unit in the fourth embodiment.

FIG. 18 is a first diagram showing the operation of the processor in the fourth embodiment.

FIG. 19 is a second diagram showing the operation of the processor in the fourth embodiment.

FIG. 20 is a diagram showing the configuration of the processor in the fifth embodiment.

FIG. 21 is a diagram showing, as an example, the configuration of the arithmetic unit in the fifth embodiment.

FIG. 22 is a diagram showing, as an example, the data structure in a register in the fifth embodiment.

FIG. 23 is a first diagram showing the operation of the processor in the fifth embodiment.

FIG. 24 is a second diagram showing the operation of the processor in the fifth embodiment.

FIG. 25 is a third diagram showing the operation of the processor in the fifth embodiment.

FIG. 26 is a diagram showing the configuration of the processor in the sixth embodiment.

FIG. 27 is a diagram showing, as an example, the configuration of the arithmetic unit in the sixth embodiment.

FIG. 28 is a first diagram showing the operation of the processor in the sixth embodiment.

FIG. 29 is a second diagram showing the operation of the processor in the sixth embodiment.

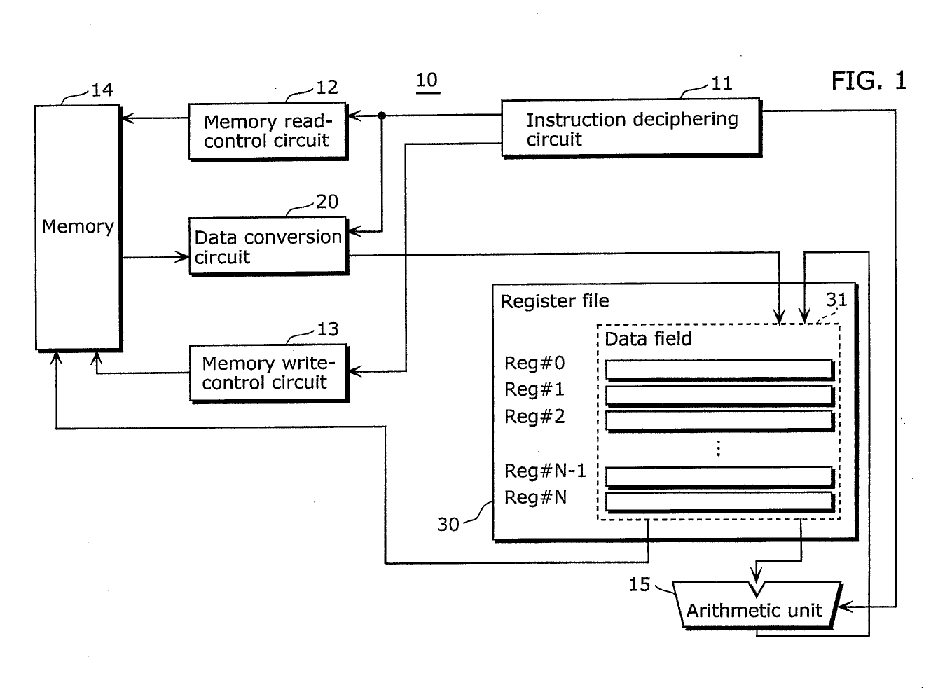

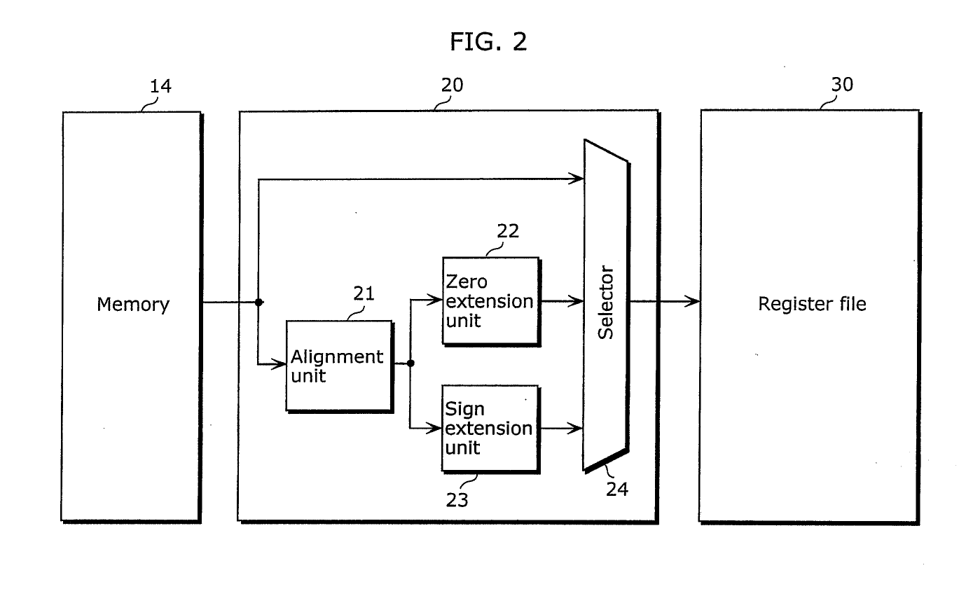

### NUMERICAL REFERENCES

10 Processor
11 Instruction deciphering circuit
12 Memory read-control circuit
13 Memory write-control circuit
14 Memory
15 Arithmetic unit
20 Data conversion circuit
21 Alignment unit
22 Zero extension unit
23 Sign extension unit
24 Selector
30 Register file
31 Data field
Reg#0 to Reg#N Register
100, 200 Processor
101 Instruction deciphering circuit
102 Tag value generation circuit
110, 210 Register file
111, 211 Tag field
112, 212 Data field
113, 213 Data attribute determination circuit
114, 214 Data conversion circuit
121, 221 Alignment unit
122, 222 Zero extension unit
123, 223 Sign extension unit
124, 224 Selector
300, 400 Processor
310, 410 Register file
311, 411 Tag field
312, 412 Data field
320, 420 Arithmetic unit
321, 421 Data attribute determination circuit
322, 422 Arithmetic processing circuit
330 Memory write-control circuit
331 Data attribute determination circuit
332 Data conversion circuit
341, 441 Alignment unit
342, 442 Zero extension unit
343, 443 Sign extension unit
344, 444 Selector
345, 445 Addition unit
401 Instruction deciphering circuit
402 Tag value generation circuit
500, 600 Processor
510, 610 Register file
520, 620 Arithmetic unit
530 Memory write-control circuit
531 Data attribute determination circuit
532 Data conversion circuit
541, 641 Selector
542, 642 Addition unit
543, 643 Selector

### BEST MODE FOR CARRYING OUT THE INVENTION

### First Embodiment

Hereafter, the first embodiment of the present invention shall be described with reference to the diagrams.

The processor in the first embodiment is characterized in performing data conversion such as bit shifting, sign extension, and zero extension immediately before outputting data from the register file to the arithmetic unit, instead of between the memory and the register file.

On that basis, the processor in the first embodiment of the present invention shall be described.

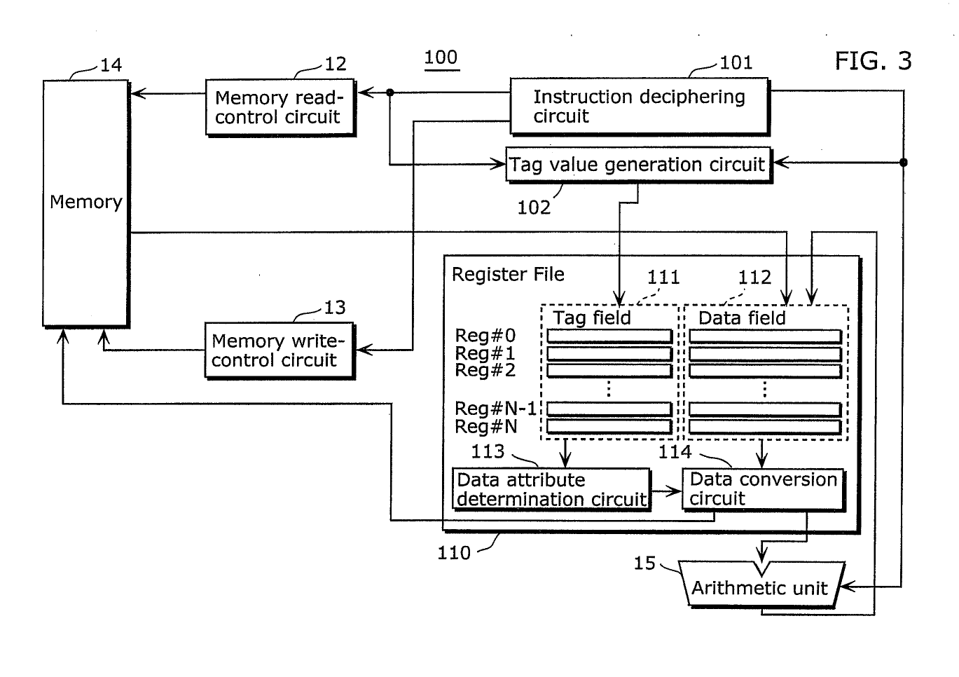

FIG. 3 is a diagram showing the configuration of the processor in the first embodiment.

As shown in the diagram, a processor 100 includes a memory read-control circuit 12, a memory write-control circuit 13, a memory 14, and an arithmetic unit 15. The processor 100 further includes an instruction deciphering circuit 101, a tag value generation circuit 102, and a register file 110.

The instruction deciphering circuit 101 outputs a signal in accordance with a deciphered instruction. For example, (a) in the case where the deciphered instruction is a load instruction, the instruction deciphering circuit 101 generates a signal characterized by the load instruction (hereafter referred to as a load instruction deciphered signal), and outputs this to the memory read-control circuit 12 and the tag value generation circuit 102. (b) In the case where the deciphered instruction is an arithmetic instruction, the instruction deciphering circuit 101 generates a signal characterized by the arithmetic instruction (hereafter referred to as an arithmetic instruction deciphered signal), and outputs this to the arithmetic unit 15 and the tag value generation circuit 102. (c) In the case where the deciphered instruction is a store instruction, the instruction deciphering unit 101 generates a signal characterized by the store instruction (hereafter referred to as a store instruction deciphered signal), and outputs this to the memory write-control circuit 13.

A “load instruction” refers to an instruction for loading data from the memory.

A “store instruction” refers to an instruction to store data into the memory.

An “arithmetic instruction” is an instruction for performing an arithmetic process.

A load instruction deciphered signal includes information such as an address, data size, and a data type which are needed for accessing the memory 14 and reading data.

An arithmetic instruction deciphered signal includes information which identifies details of an arithmetic process. A store instruction deciphered signal includes information such as an address, data size, and a data type which are needed for accessing the memory 14 and storing data.

In accordance with the load instruction deciphered signal outputted from the instruction deciphering circuit 101, the tag value generation circuit 102 generates a tag value indicating the attributes of data to be stored in the register file 110 according to the load instruction deciphered signal, and stores the generated tag value into the register file 110 in association with the data. Furthermore, in accordance with the arithmetic instruction deciphered signal outputted from the instruction deciphering circuit 101, the tag value generation circuit 102 generates a tag value indicating the attributes of data to be stored in the register file 110 according to the arithmetic instruction deciphered signal, and stores the generated tag value into the register file 110 in association with the data.

Note that a tag value indicates the attributes of the data to which the tag value is associated. Furthermore, attributes include information such as data size, data type, and validity or invalidity of each bit making up the data.

The register file 110 includes plural registers, each of which is configured of a tag field 111 and a data field 112. The register file 110 further includes a data attribute determination circuit 113 and a data conversion circuit 114.

A tag value is stored in the tag field 111, and data associated with such tag value is stored in the data field 112.

Furthermore, each corresponding data field 112 and tag field 111 have a one-to-one relationship, and are managed with a register number (Reg#0 to Reg#N).

When data is read from the data field 112, the data attribute determination circuit 113 reads the tag value associated with the data from the tag field 111, and determines the attributes of such data based on the read tag value. Subsequently, the data attribute determination circuit 113 outputs the determination result, as a data attribute determination signal, to the data conversion circuit 114.

When reading data from the data field 112, the data conversion circuit 114 determines whether or not to convert such data, based on the data attribute determination signal. In the case where conversion is to be performed as a result of the determination, the read data is converted based on the data attribute determination signal, and the converted data is outputted. In the case where conversion is not to be performed, the read data is outputted directly without being converted.

The memory read-control circuit 12 outputs, in accordance with a load instruction deciphered signal outputted from the instruction deciphering circuit 101, a signal characterized by the load instruction deciphered signal (hereinafter referred to as a memory read-control signal) to the memory 14.

The memory write-control circuit 13 outputs, in accordance with a store instruction deciphered signal outputted from the instruction deciphering circuit 101, a signal characterized by the store instruction deciphered signal (hereinafter referred to as a memory write-control signal) to the memory 14.

The memory 14 stores, in accordance with the memory read-control signal outputted by the memory read-control circuit 12, data identified by the memory read-control signal into the register file 110. Furthermore, in accordance with the memory write-control signal outputted from the memory write-control circuit 13, the memory 14 reads, from the register file 110, data identified by the memory write-control signal.

Note that the data read from the memory 14 is stored in the register file 110 without the performance of data conversion such as bit shifting, sign extension, and zero extension.

In accordance with the arithmetic instruction deciphered signal outputted from the instruction deciphering circuit 101, the arithmetic unit 15 reads, from the register file 110, data identified by the arithmetic instruction deciphered signal and performs the arithmetic process identified by the arithmetic instruction deciphered signal on the data. Then, the data obtained through the performance of the arithmetic process is stored in the register file 110.

Next, the configuration of the register file in the first embodiment shall be described as an example.

Here, the case where an arithmetic process is performed on data read from a register (Reg#0), and the data obtained through the performance of the arithmetic process, in other words the arithmetic result, is stored in the register (Reg#1) shall be described as an example.

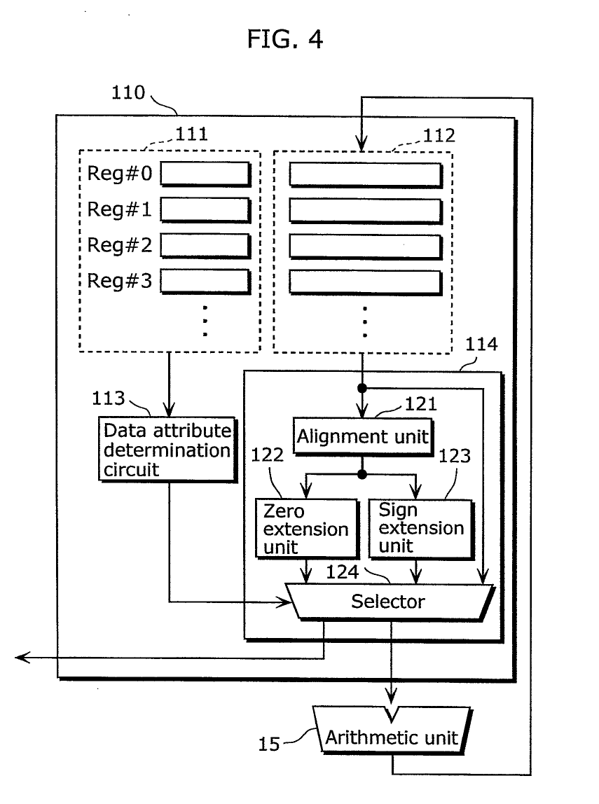

FIG. 4 is a diagram showing, as an example, the configuration of the register file in the first embodiment.

As shown in the diagram, the data attribute determination circuit 113 reads the tag value from the tag field 111 of the register (Reg#0), and determines the attributes of data read from the data field 112 of the register (Reg#0) based on the read tag value. Subsequently, the data attribute determination circuit 113 outputs the determination result, as a data attribute determination signal, to a selector 124.

Correspondingly, an alignment unit 121 performs an alignment process on the data read from the data field 112 of the register (Reg#0), and outputs the processed data to a zero extension unit 122 and a sign extension unit 123.

An “alignment process” refers to the aligning of a partial bit string of M-bit data (M being a positive integer) so as to align with the lowest bit, and then outputting the result. For example, in the case where a partial bit string, from the 8^{th} bit to the 15^{th} bit, of 32-bit data is inputted, a bit string which is aligned with the 0^{th} bit to the 7^{th} bit is outputted.

The zero extension unit 122 performs zero extension on the data outputted from the alignment unit 121, and outputs the processed data to the selector 124.

“Zero extension process”, in the case of extending M-bit data (M being a positive integer) to N-bit data (N being a positive integer greater than M), refers to the setting of the bits, from the M−1^{th} bit to the most significant bit, to “0”, and outputting the result.

The sign extension unit 123 performs sign extension on the data outputted from the alignment unit 121, and outputs the processed data to the selector 124.

A “sign extension process”, in the case of extending M-bit data (M being a positive integer) to N-bit data (N being a positive integer greater than M), refers to the setting of bits, from the M−1^{th} bit to the most significant bit, to “the value of the signed bit of the M-bit data”, and outputting the result.

The selector 124 selects, in accordance with the data attribute determination signal outputted from the data attribute determination circuit 113, any one of: the data outputted from the data field 112 of the register (Reg#0); the data outputted from the zero extension unit 122; and the data outputted from the sign extension unit 123, and then outputs the selected data to the arithmetic unit 15.

Then, the arithmetic unit 15 performs an arithmetic process on the data outputted from the selector 124, and stores the data obtained through the performance of the arithmetic process, in other words the arithmetic result, to the data field 112 of the register (Reg#1).

Next, the data structure in a register in the first embodiment shall be described as an example.

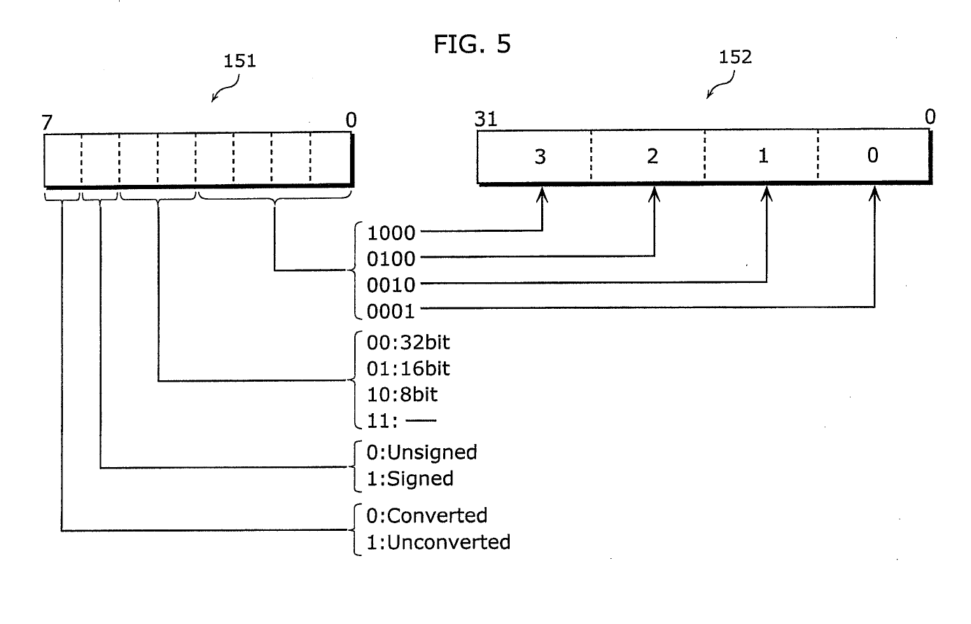

FIG. 5 is a diagram showing, as an example, the data structure in a register in the first embodiment.

As shown in the diagram, a register is configured of an 8-bit tag field 151, and a 32-bit data field.

The lowest 4 bits, from the 0^{th} bit to the 3^{rd} bit, of the tag field 151 are valid bits, in other words, they indicate from where in the data field 152 data is stored. For example, in the case of (a) “1000”, it is indicated that data is stored from the 3^{rd} bit string (the 31^{st} bit). In the case of (b) “0100”, it is indicated that data is stored from the 2nd bit string (the 23^{rd} bit). In the case of (c) “0010”, it is indicated that data is stored from the 1^{st} bit string (the 15^{th} bit). In the case of (d) “0001”, it is indicated that data is stored from the 0^{th} bit string (the 7^{th} bit).

The two bits, from the 4^{th} bit to the 5^{th} bit, of the tag field 151 indicate the size of the data stored in the data field 152. For example, (a) “00” indicates 32 bits, (b) “01” indicates 16 bits, and (c) “10” indicates 8 bits. Note that “11” indicates “empty”.

The 6^{th} bit of the tag field 151 indicates whether or not data stored in the data field 152 is signed data. For example, (a) “0” indicates non-signed data, and (b) “1” indicates signed data.

The 7^{th} bit of the tag field 151 indicates whether or not data stored in the data field 152 is data on which data conversion, such as bit shifting, sign extension, and zero extension, has been performed. For example, (a) “0” indicates converted, in other words, converted data, (b) “1” indicates unconverted, in other words, pre-conversion data.

Next, an example of data conversion in the data conversion circuit in the first embodiment shall be described.

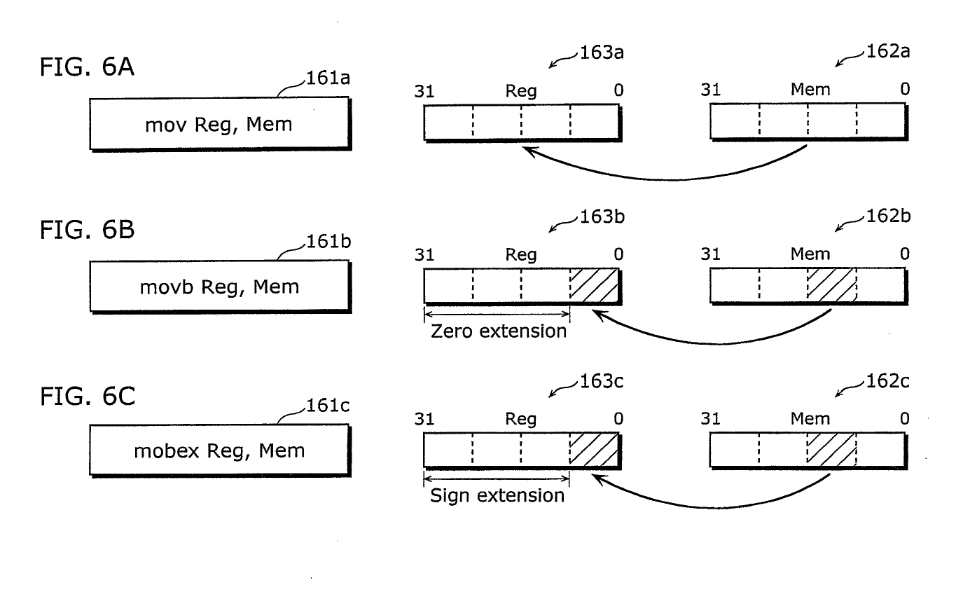

FIG. 6A to FIG. 6C are diagrams showing an example of data conversion in the data conversion circuit in the first embodiment.

As shown in the diagram, the details of the data conversion by the data conversion circuit 114 is different, according to the following cases (1) to (3).

(1) In the case where an instruction 161a (mov Reg, Mem) is executed and 32-bit data is read from a memory 162b, the data conversion circuit 114 does not convert. In other words, the 32-bit data is stored in the 32-bit register 163b (See FIG. 6A).

(2) In the case where an instruction 161b (movb Reg, Mem) is executed and, out of the 32-bit data, the valid 8-bit data from the 1^{st} bit string is read from the memory 162b, the data conversion circuit 114 aligns the data with the lowest bit and converts it into zero-extended data. Then, the converted data is stored in the 32-bit register 163b (See FIG. 6B).

(3) In the case where an instruction 161c (movbex Reg, Mem) is executed and, out of the 32-bit data, the valid 8-bit data from the 1^{st} bit string is read from the memory 162b, the data conversion circuit 114 aligns the data with the lowest bit and converts it into sign-extended data. Then, the converted data is stored in the 32-bit register 163c (see FIG. 6C).

Next, the operation of the processor in the first embodiment shall be described.

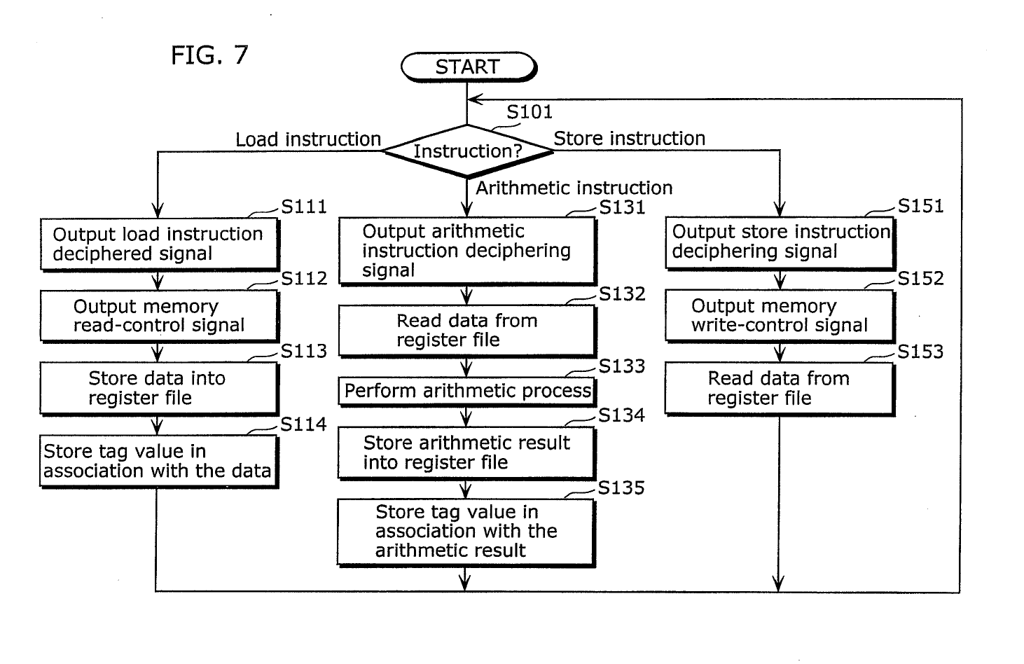

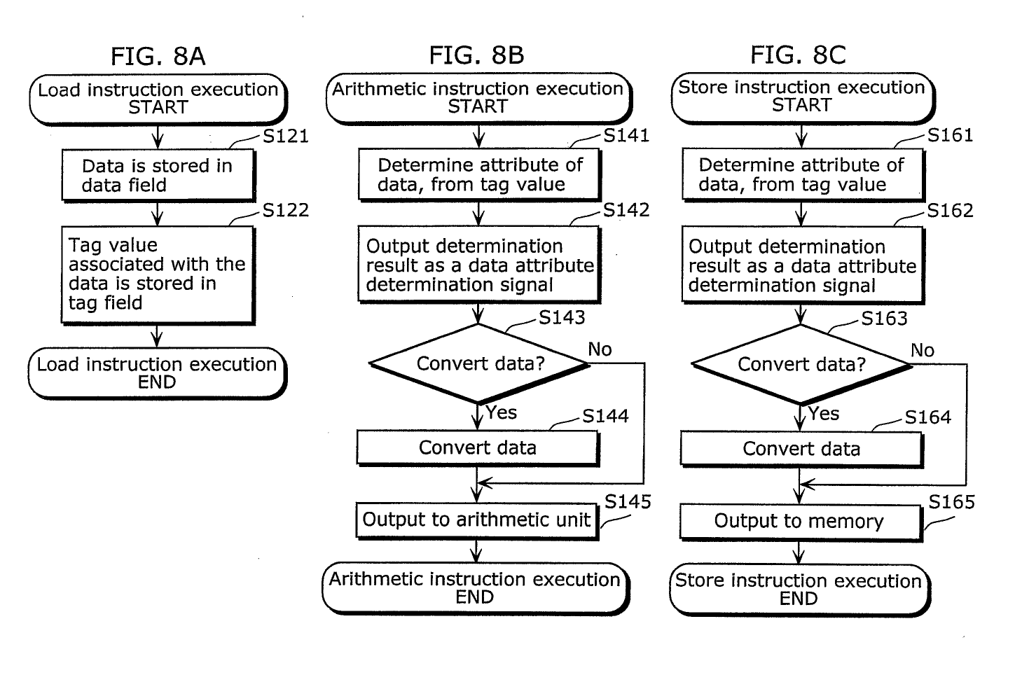

FIG. 7, and FIG. 8A to FIG. 8C are diagrams showing the operation of the processor in the first embodiment.

As shown in FIG. 7, the instruction deciphering circuit 101 executes any of the following (1) to (3) in accordance with the deciphered instruction (step S101).

(1) In the case where the deciphered instruction is a load instruction, the instruction deciphering circuit 101 outputs a load instruction deciphered signal to the memory read-control circuit 12 and the tag value generation circuit 102 (step S111).

Correspondingly, the memory read-control unit 12 outputs a memory read-control signal to the memory 14 (step S112). The memory 14 stores the data identified by the memory read-control signal into the register file 110 (step S113). On the other hand, the tag value, which indicates attributes of the data that is stored in the register file 110 in accordance with the load instruction deciphered signal, is stored into the register file 110, in association with such data, by the tag value generation circuit 102 (step S114).

At this time, as shown in FIG. 8A, in the register file 110, data identified by the load instruction deciphered signal is stored in the data field 112 (step S121), and the tag value associated with such data is stored in the tag field 111 (step S122).

(2) In the case where the deciphered instruction is an arithmetic instruction, the instruction deciphering circuit 101 outputs an arithmetic instruction deciphered signal to the arithmetic unit 15 and the tag value generation circuit 102.

Correspondingly, the arithmetic unit 15 reads, from the register file 110, the data identified by the arithmetic instruction deciphered signal (step S132), and performs the arithmetic process identified by the arithmetic instruction deciphered signal on the read data (step S133). Then, the data obtained through the performance of the arithmetic process is stored in the register file 110 (step S134). On the other hand, the tag value, which indicates attributes of the data that is stored in the register file 110 in accordance with the arithmetic instruction deciphered signal, is stored into the register file 110, in association with the data obtained through the performance of the arithmetic process, by the tag value generation circuit 102 (step S135).

At this time, as shown in FIG. 8B, in the register file 110, the data attribute determination unit 113 determines, from the tag value associated with the data identified by the arithmetic instruction deciphered signal, the attributes of such data (step S141), and outputs the determination result, as a data attribute determination signal, to the data conversion circuit 114 (step S142). Then, the data conversion circuit 114 determines whether or not to convert the data, based on the data attribute determination signal (step S143). In the case where conversion is to be performed as a result of the determination (Yes in step S143), the data is converted based on the data attribute determination signal (step S144), and the converted data is outputted to the arithmetic unit 15 (step S145).

Note that in the case where conversion is not to be performed (No in step S143), the data identified by the arithmetic instruction deciphered signal is outputted directly to the arithmetic unit 15 without being converted.

(3) In the case where the deciphered instruction is a store instruction, the instruction deciphering unit 101 outputs a store instruction deciphered signal to the memory write-control circuit 13 (step S151).

Correspondingly, the memory write-control circuit 13 outputs a memory write-control signal to the memory 14 (step S152). The memory 14 reads the data identified by the memory write-control signal, from the register file 110 (step S153).

At this time, as shown in FIG. 8C, in the register file 110, the data attribute determination unit 113 determines, from the tag value associated with the data identified by the store instruction deciphered signal, the attributes of such data (step S161), and outputs the determination result, as a data attribute determination signal, to the data conversion circuit 114 (step S162). Then, the data conversion circuit 114 determines whether or not to convert the data, based on the data attribute determination signal (step S163). In the case where conversion is to be performed as a result of the determination (Yes in step S163), the data is converted based on the data attribute determination signal (step S164), and the converted data is outputted to the memory 14 (step S165).

Note that in the case where conversion is not to be performed (No in step 163), the data identified by the memory write-control signal is outputted directly to the memory 14 without being converted.

As described thus far, according to the processor 100 in the first embodiment, the tag field 111, the data field 112, the data attribute determination unit 113, and the data conversion circuit 114 are included in the register file 110.

Accordingly, since data conversion such as bit shifting, sign extension, and zero extension, can be performed immediately before data is outputted from the register file 110 to the arithmetic unit 15, instead of between the memory 14 and the register file 110, it becomes possible to reduce the delay occurring between the memory 14 and the register file 110. In addition, since already-existing components can be used for the arithmetic unit 15, designing is also easy.

### Second Embodiment

Hereafter, the second embodiment of the present invention shall be described with reference to the diagrams.

The processor in the second embodiment is characterized in performing data conversion such as bit shifting, sign extension, and zero extension within the register file before outputting data to the arithmetic unit, instead of between the memory and the register file.

On that basis, the processor in the second embodiment shall be described.

Note that constituent elements that are the same as in the first embodiment are given the same reference numbers and their description shall be omitted.

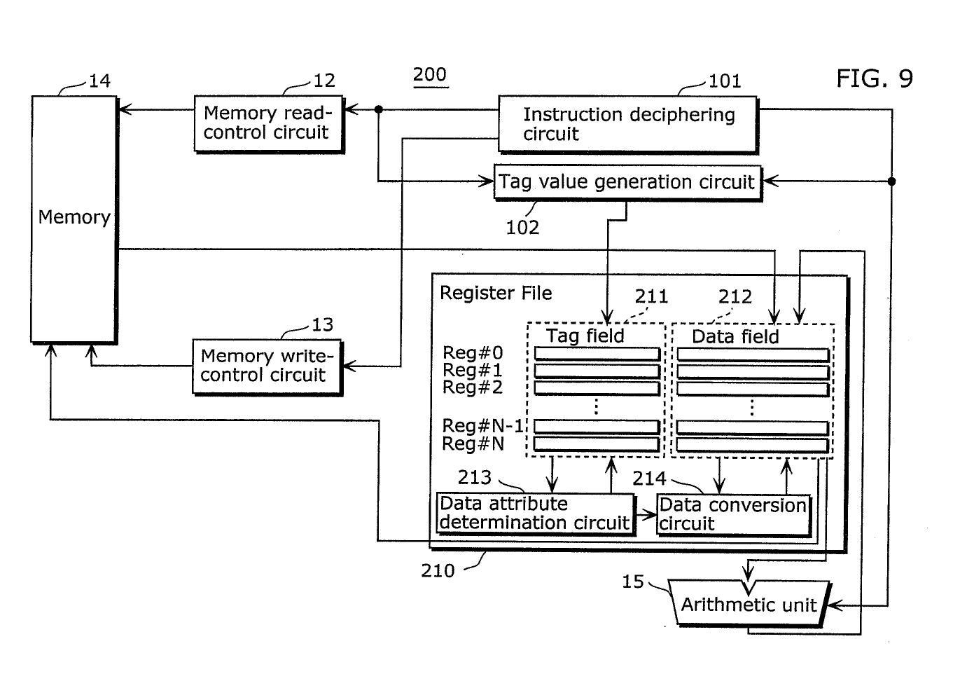

FIG. 9 is a diagram showing the configuration of the processor in the second embodiment.

As shown in the diagram, a processor 200 is different, compared to the processor 100 in the first embodiment, in including a register file 210 in place of the register file 110 (see FIG. 3).

The register file 210 is different, compared to the register file 110, in including a tag field 211, a data field 212, a data attribute determination circuit 213, and a data conversion circuit 214 in place of the tag field 111, the data field 112, the data attribute determination circuit 113, and the data conversion circuit 114.

When data is newly stored in the data field 212, the data attribute determination circuit 213 reads the tag value associated with the data from the data field 211, and determines the attributes of such data based on the read tag value. Subsequently, the data attribute determination circuit 213 outputs the determination result, as a data attribute determination signal, to the data conversion circuit 214. Furthermore, it is determined whether or not to convert the tag value based on the determination result. In the case where conversion is to be performed as a result of the determination, the tag value is converted based on the determination result, and the converted tag value is stored in the register file 210 so as to replace the pre-conversion tag value with the converted tag value.

When data is newly stored in the data field 212, the data conversion circuit 214 determines whether or not to convert such data, based on the data attribute determination signal. In the case where conversion is to be performed as a result of the determination, the read data is converted based on the data attribute determination signal, and the converted data is outputted to the data field 212. In the case where conversion is not to be performed, the data is not converted.

Next, the configuration of the register file in the second embodiment shall be described as an example.

Here, the case where data conversion is performed on data read from the register (Reg#0), and the converted data is stored in the register (Reg#0) is discussed as an example.

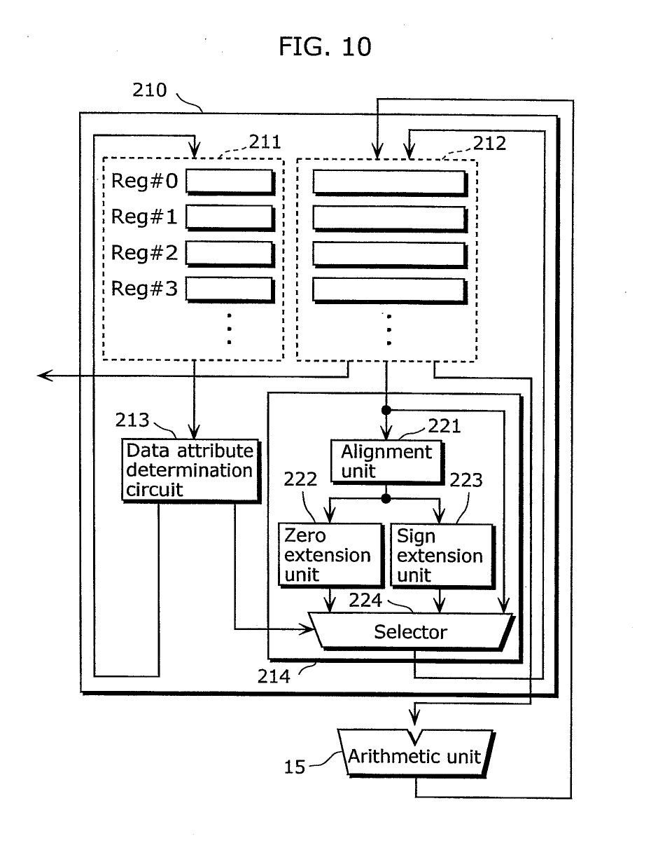

FIG. 10 is a diagram showing, as an example, the configuration of the register file in the second embodiment.

As shown in the diagram, the data attribute determination circuit 213 reads the tag value from the tag field 211 of the register (Reg#0), and determines the attributes of data read from the data field 212 of the register (Reg#0) based on the read tag value. Subsequently, the data attribute determination circuit 213 outputs the determination result, as a data attribute determination signal, to a selector 224 and the like.

Correspondingly, an alignment unit 221 performs an alignment process on the data outputted from the data field 212 of the register (Reg#0), and outputs the processed data to a zero extension unit 222 and a sign extension unit 223.

Note that since the zero extension unit 222 and the sign extension unit 223 have the same configuration as the zero extension unit 122 and the sign extension unit 123 in the first embodiment, their description shall be omitted.

The selector 224 selects, in accordance with the data attribute determination signal outputted from the data attribute determination circuit 213, any one of: the data outputted from the data field 212 of the register (Reg#0); the data outputted from the zero extension unit 222; and the data outputted from the sign extension unit 223, and outputs the selected data to the data field 112 of the register (Reg#0).

In addition, the data attribute determination circuit 213 converts the read tag value and stores the converted tag value into the tag field 212 of the register (Reg#0).

Then, the arithmetic unit 15 performs an arithmetic process on the converted data outputted from the data field 212, and stores the data obtained through the performance of the arithmetic process, in other words the arithmetic result, into the data field 212 of a register (Reg#1) or the like.

Next, the operation of the processor 200 in the second embodiment shall be described.

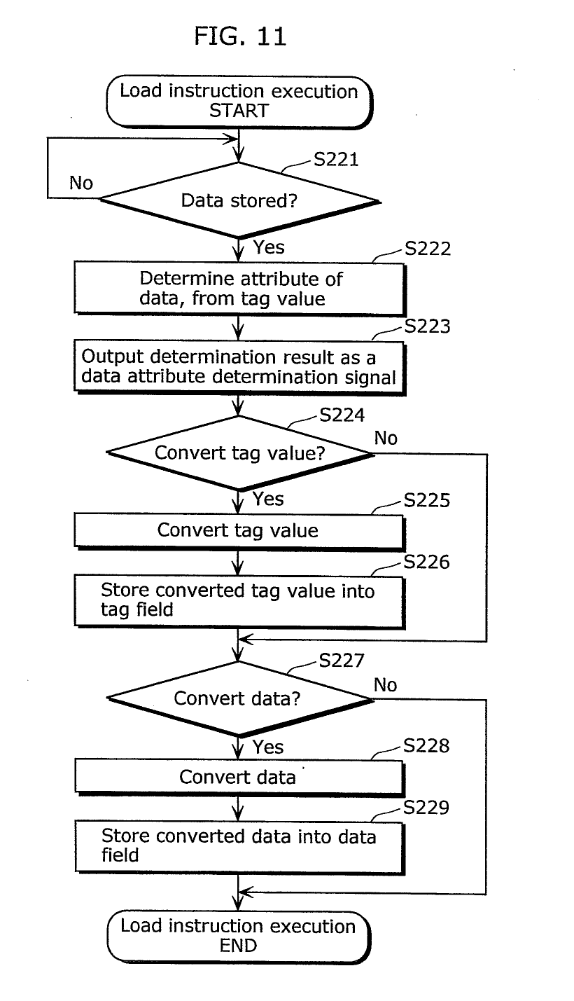

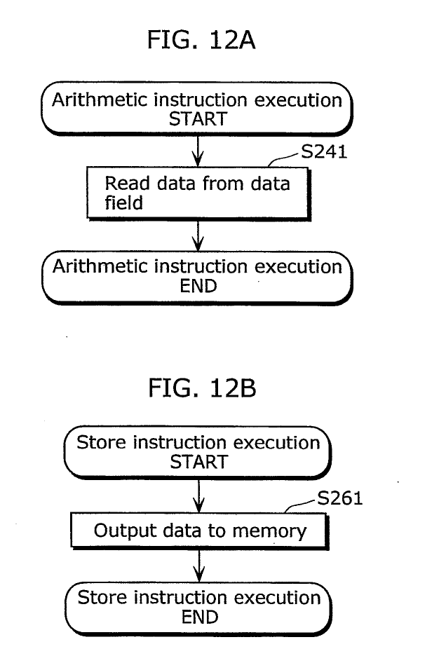

FIG. 11, FIG. 12A, and FIG. 12B are diagrams showing the operation of the processor in the second embodiment.

As shown in FIG. 11, FIG. 12A and FIG. 12B, the processor 200 is different compared to the processor 100 in the first embodiment with respect to the following points (1) to (3).

(1) With regard to the operation during the execution of a load instruction, the following points are different compared to the operation (steps S11 to S114, and S121 to S122) in the first embodiment (see FIG. 8A and FIG. 11).

In the register file 210, in place of the operation (steps S121 to S122) for the register file 110 in the first embodiment, when the load instruction is executed and data is newly stored in the data field 212 (step S221), the data attribute determination unit 213 determines, from the tag value associated with the data, the attributes of the data (step S222), and outputs the determination result, as a data attribute signal, to the data conversion circuit 213 (step S223). Furthermore, it is determined whether or not to convert the tag value based on the determination result (step S224). In the case where conversion is to be performed as a result of the determination (Yes in step S224), the tag value is converted based on the determination result (step S225), and the converted tag value is stored in the tag field 211 so as to replace the pre-conversion tag value with the converted tag value (step S226). Then, the data conversion circuit 213 determines whether or not to convert the data, based on the data attribute determination signal (step S227). In the case where conversion is to be performed as a result of the determination (Yes in step S227), the data is converted based on the data attribute determination signal (step S228), and the converted data is stored into the data field 212 so as to replace the pre-conversion data with the converted data (step s229).

(2) With regard to the operation during the execution of an arithmetic instruction, the following points are different compared to the operation (steps S131 to S135, and S141 and 144) in the first embodiment (see FIG. 8B and FIG. 12A).

In the register file 210, in place of the operation (steps S141 to S144) for the register file 110 in the first embodiment, when the arithmetic instruction is executed, data is read from the data field 212 (step S241).

(3) With regard to the operation during the execution of a store instruction, the following points are different compared to the operation (steps S151 to S153, and S161 to S164) in the first embodiment (see FIG. 8C and FIG. 12B).

In the register file 210, in place of the operation (steps S161 to S164) for the register file 110 in the first embodiment, when the store instruction is executed, data stored in the data field 212 is outputted to the memory 14 (step S261).

As explained thus far, according to the processor 200 in the second embodiment, the tag field 211, the data field 212, the data attribute determination unit 213, and the data conversion circuit 214 are included in the register file 210.

Accordingly, since data conversion such as bit shifting, sign extension, and zero extension, can be performed within the register file 210, before data is outputted from the file 210 to the arithmetic unit 15, instead of between the memory 14 and the register file 210, it becomes possible to reduce the delay occurring between the memory 14 and the register file 210. Furthermore, since data conversion is performed within the register file 210, an increase in the delays occurring between the register file 210 and the arithmetic unit 15, and between the register file 210 and the memory 14 is not caused. In addition, since already-existing components can be used for the arithmetic unit 15, designing is also easy.

### Third Embodiment

Hereafter, the third embodiment of the present invention shall be described with reference to the diagrams.

The processor in the third embodiment is characterized in performing data conversion such as bit shifting, sign extension, and zero extension within the arithmetic unit and the memory write-control circuit, instead of between the memory and the register file.

On that basis, the processor in the third embodiment shall be described.

Note that constituent elements that are the same as in the first embodiment are given the same reference numbers and their explanation shall be omitted.

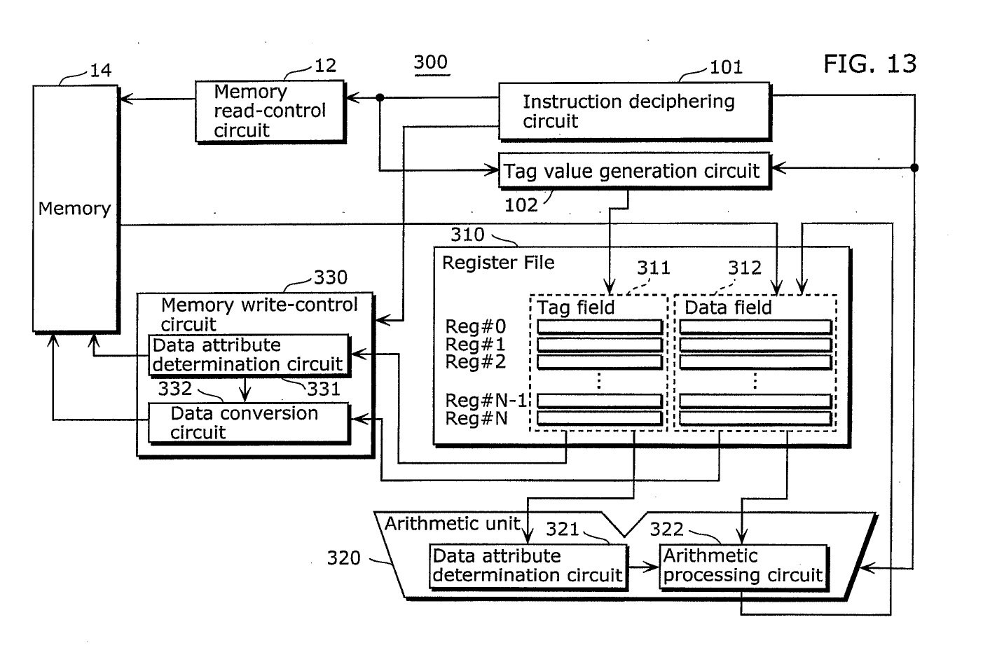

FIG. 13 is a diagram showing the configuration of the processor in the third embodiment.

As shown in the diagram, a processor 300 is different, compared to the processor 100 in the first embodiment, with respect to the following points (1) to (3) (see FIG. 3).

(1) The processor 300 includes a register file 310 in place of the register file 110.

The register file 310 is different, compared to the register file 110, in that the data attribute determination circuit 113 and the data conversion circuit 114 are not included.

(2) The processor 300 includes an arithmetic unit 320 in place of the arithmetic unit 15.

The arithmetic unit 320 is different, compared to the arithmetic unit 15, in including a data attribute determination circuit 321 and an arithmetic processing circuit 322.

The data attribute determination circuit 321 reads, from the register file 310, the tag value associated with the data identified by an arithmetic instruction deciphered signal, and determines the attributes of such data based on the read tag value. Subsequently, the data attribute determination circuit 321 outputs the determination result, as a data attribute determination signal, to the arithmetic processing circuit 322.

The arithmetic processing circuit 322 reads, from the register file 310, the data identified by the arithmetic instruction deciphered signal. Then, the arithmetic processing circuit 322 determines whether or not to convert the read data, based on the data attribute determination signal. In the case where conversion is to be performed as a result of the determination, the read data is converted based on the data attribute determination signal, and an arithmetic process is performed on the converted data. Then, the data obtained through the performance of the arithmetic process is stored in a data field 311 of the register file 310.

In the case where conversion is not to be performed, the arithmetic process is performed directly without the read data being converted.

(3) The processor 300 includes a memory write-control circuit 330 in place of the memory write-control circuit 13.

The memory write-control circuit 330 is different, compared to the memory write-control circuit 13, in including a data attribute determination circuit 331 and a data conversion circuit 332.

The data attribute determination circuit 331 reads, from the register file 310, the tag value associated with the data identified by a store instruction deciphered signal, and determines the attributes of such data based on the read tag value. Subsequently, the data attribute determination circuit 331 outputs the determination result, as a data attribute determination signal, to the data conversion circuit 332. In addition, the data attribute determination circuit 331 generates a memory write-control signal in accordance with the store instruction deciphered signal and the tag value, and outputs this to the memory 14.

The data conversion circuit 332 reads, from the register file 310, the data identified by the store instruction deciphered signal, and determines whether or not to convert the read data based on the data attribute determination signal. In the case where conversion is to be performed as a result of the determination, the read data is converted based on the data attribute determination signal, and the converted data is outputted to the memory 14.

In the case where conversion is not to be performed, the read data is stored directly to the memory 14 without being converted.

Next, the configuration of the arithmetic unit in the third embodiment shall be described as an example.

Here, the case where an adding process is performed on data read from a register (Reg#0), and the data obtained through the performance of the adding process, in other words the adding result, is stored in a register (Reg#1) shall be described as an example.

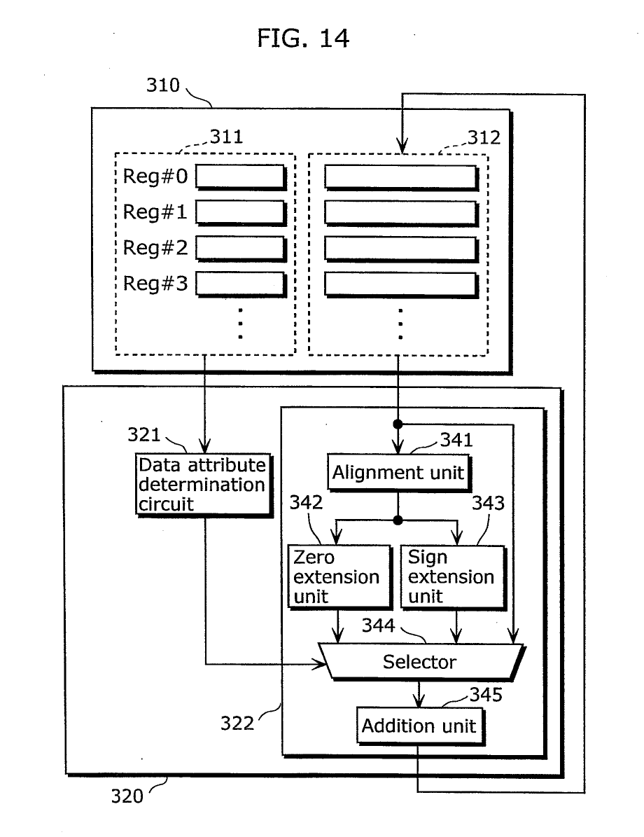

FIG. 14 is a diagram showing, as an example, the configuration of the arithmetic unit in the third embodiment.

As shown in the diagram, the data attribute determination circuit 321 reads the tag value from the tag field 311 of the register (Reg#0), and determines the attributes of data read from the data field 312 of the register (Reg#0) based on the read tag value. Subsequently, the data attribute determination circuit 321 outputs the determination result, as a data attribute determination signal, to a selector 344.

Correspondingly, an alignment unit 341 performs an alignment process on the data outputted from the data field 312 of the register (Reg#0), and outputs the processed data to a zero extension unit 342 and a sign extension unit 343.

The zero extension unit 342 performs a zero extension process on the data outputted from the alignment unit 341, and outputs the processed data to the selector 344.

The sign extension unit 343 performs a sign extension process on the data outputted from the alignment unit 341, and outputs the processed data to the selector 344.

The selector 344 selects, in accordance with the data attribute determination signal outputted from the data attribute determination circuit 321, any one of: the data outputted from the data field 312 of the register (Reg#0); the data outputted from the zero extension unit 342; and the data outputted from the sign extension unit 343, and outputs the selected data to an addition unit 345.

The addition unit 345 performs an adding process on the data outputted from the selector 344, and stores the data obtained through the performance of the adding process, in other words the arithmetic result, to the data field 312 of the register (Reg#1).

Next, the operation of the processor 300 in the third embodiment shall be described.

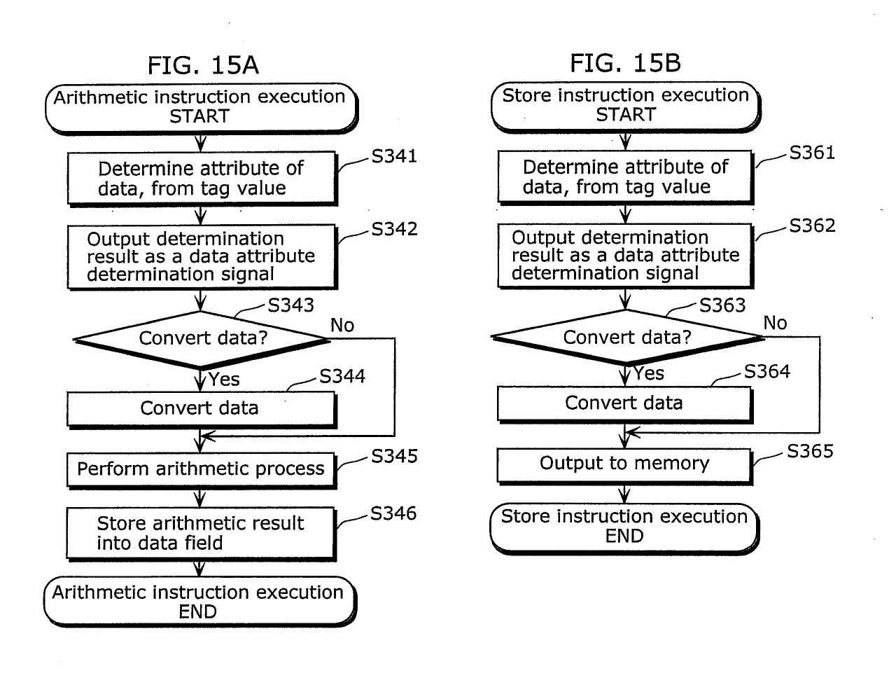

FIG. 15A and FIG. 15B are diagrams showing the operation of the processor in the third embodiment.

As shown in the diagram, a processor 300 is different, compared to the processor 100 in the first embodiment, with respect to the following point.

(1) Since the operation during the execution of a load instruction is the same as the operation (steps S111 to S114, and S121 to S122) in the first embodiment, description shall be omitted.

(2) With regard to the operation during the execution of an arithmetic instruction, the following points are different compared to the operation (steps S131 to S135, and S141 and 145) in the first embodiment (see FIG. 8B and FIG. 15A).

In the arithmetic unit 320, in place of the operation (steps S141 to S144) for the register file 110 in the first embodiment, when the arithmetic instruction is executed, the data attribute determination circuit 321 determines, from the tag value associated with the data identified by the arithmetic instruction deciphered signal, the attributes of such data (step S341), and outputs the determination result, as a data attribute determination signal, to the arithmetic processing circuit 322 (step S342). Then, the arithmetic processing circuit 322 determines whether or not to convert the data, based on the data attribute determination signal (step S343). In the case where conversion is to be performed as a result of the determination (Yes in step S343), the data is converted based on the data attribute determination signal (step S344), and an arithmetic process is performed on the converted data (step S345). The data obtained through the performance of the arithmetic process is stored in a data field 312 of the register file 310 (step S346).

Note that in the case where conversion is not to be performed (No in step S343), the arithmetic process is performed directly on the data identified by the arithmetic instruction deciphered signal without such data being converted.

(3) With regard to the operation during the execution of a store instruction, the following points are different compared to the operation (steps S151 to S153, and S161 to S165) in the first embodiment (see FIG. 8C and FIG. 15B).

In the memory write-control circuit 330, in place of the operation (steps S161 to S164) for the register file 110 in the first embodiment, when the store instruction is executed, the data attribute determination circuit 331 determines, from the tag value associated with the data identified by the memory write-control signal, the attributes of such data (step S361), and outputs the determination result, as a data attribute determination signal, to the data conversion circuit 332 (step S362). Then, the data conversion circuit 332 determines whether or not to convert the data, based on the data attribute determination signal (step S363). In the case where conversion is to be performed as a result of the determination (Yes in step S363), the data is converted based on the data attribute determination signal (step S364), and the converted data is outputted to the memory (step S365).

Note that in the case where conversion will not be performed (No in step 363), the data identified by the memory write-control signal is outputted directly to the memory 14 without being converted.

As explained thus far, according to the processor 300 in the third embodiment, tag fields 311 and data fields 312 are included in the register file 310, and the data attribute determination circuit 321 and the arithmetic processing circuit 322 are included in the arithmetic unit 320, and the data attribute determination circuit 331 and the data conversion circuit 332 are included in the memory write-control unit 330.

Accordingly, since data conversion such as bit shifting, sign extension, and zero extension, can be performed within the arithmetic unit 320 and the memory write-control circuit 330, instead of between the memory 14 and the register file 310, it becomes possible to reduce the delay occurring between the memory 14 and the register file 310.

### Fourth Embodiment

Next, the fourth embodiment of the present invention shall be described with reference to the diagrams.

The processor in the fourth embodiment is characterized in performing data conversion such as bit shifting, sign extension, and zero extension within the arithmetic unit and the memory write-control circuit, instead of between the memory and the register file.

On that basis, the processor in the fourth embodiment shall be described.

Note that constituent elements that are the same as in the third embodiment are given the same reference numbers and their description shall be omitted.

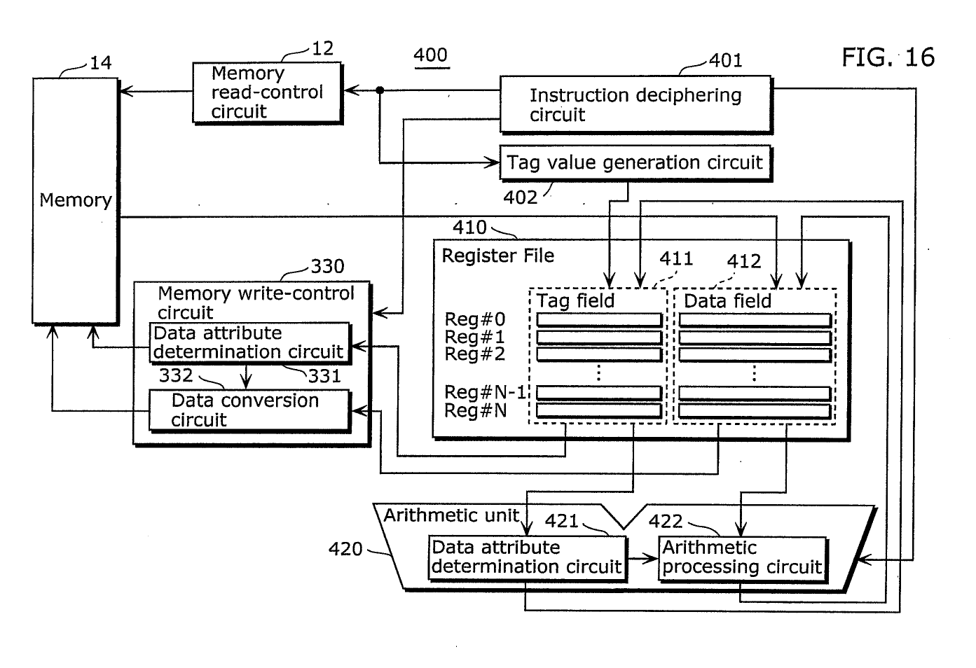

FIG. 16 is a diagram showing the configuration of the processor in the fourth embodiment.

As shown in the diagram, a processor 400 is different, compared to the processor 300 in the third embodiment, with respect to the following points (1) to (3) (see FIG. 5).

(1) The processor 400 includes an instruction deciphering circuit 401 in place of the instruction deciphering circuit 101.

In the case of executing an arithmetic instruction, the instruction deciphering unit 401 is different, compared to the instruction deciphering circuit 101, in terms of not outputting an arithmetic deciphered signal to a tag value generation circuit 402.

(2) The processor 400 includes the tag value generation circuit 402 in place of the tag value generation circuit 102.

The tag value generation circuit 402 is different, compared to the tag value generation circuit 102, in terms of not generating a tag value indicating the attributes of the data obtained through the performance of the arithmetic process identified by an arithmetic instruction deciphered signal.

(3) The processor 400 includes an arithmetic unit 420 in place of the arithmetic unit 320.

The arithmetic unit 420 is different, compared to the arithmetic unit 320, in including a data attribute determination circuit 421 and an arithmetic processing circuit 422, in place of the data attribute determination circuit 321 and the arithmetic processing circuit 322.

The data attribute determination circuit 421 reads, from a register file 410, the tag value associated with the data identified by an arithmetic instruction deciphered signal, and determines the attributes of such data based on the read tag value. Subsequently, the data attribute determination circuit 421 outputs the determination result, as a data attribute determination signal, to the arithmetic processing circuit 422. In addition, the data attribute determination circuit 421 generates a tag value which indicates attributes of the data obtained through the performance of the arithmetic process identified by the arithmetic instruction deciphered signal, and stores the generated tag value into the register file 410, in association with the data obtained through the performance of the arithmetic process.

The arithmetic processing circuit 422 reads, from the register file 410, the data identified by the arithmetic instruction deciphered signal, and determines whether or not to convert the read data based on the data attribute determination signal. In the case where conversion is to be performed as a result of the determination, the read data is converted based on the data attribute determination signal, and the arithmetic process identified by the arithmetic instruction deciphered signal is performed on the converted data. Then, the data obtained through the performance of the arithmetic process is stored in the register file 410.

Note that, in the case where conversion is not to be performed, the arithmetic process is performed directly without the read data being converted.

Next, the configuration of the arithmetic unit in the fourth embodiment shall be described as an example.

Here, the case where an arithmetic process is performed on data read from a register (Reg#0), and the data obtained through the performance of the arithmetic process, in other words the arithmetic result, is stored in a register (Reg#1) shall be described as an example.

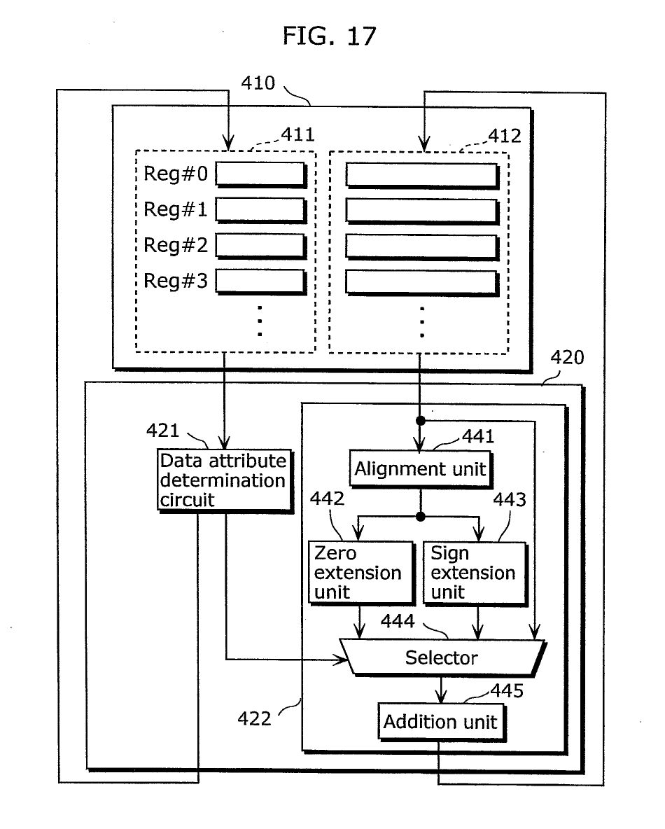

FIG. 17 is a diagram showing, as an example, the configuration of the arithmetic unit in the fourth embodiment. As shown in the diagram, the data attribute determination circuit 421 reads the tag value from a tag field 411 of the register (Reg#0), and determines the attributes of data read from a data field 412 of the register (Reg#0) based on the read tag value. Subsequently, the data attribute determination circuit 421 outputs the determination result, as a data attribute determination signal, to a selector 444.

Correspondingly, an alignment unit 441 performs an alignment process on the data outputted from the data field 412 of the register (Reg#0), and outputs the processed data to a zero extension unit 442 and a sign extension unit 443.

The selector 444 selects, in accordance with the data attribute determination signal outputted from the data attribute determination circuit 421, any one of: the data outputted from the data field 412 of the register (Reg#0); the data outputted from the zero extension unit 442; and the data outputted from the sign extension unit 443, and outputs the selected data to an addition unit 445.

The addition unit 445 performs an adding process on the data outputted from the selector 444, and stores the data obtained through the performance of the adding process, in other words the arithmetic result, to the data field 412 of the register (Reg#1).

In addition, the data attribute determination unit 421 generates a tag value for the data obtained through the performance of the adding process by the addition unit 445, in other words the arithmetic result, and stores the generated tag value in the tag field 411 of the register (Reg#1).

Note that since the zero extension unit 442 and the sign extension unit 443 have the same configuration as the zero extension unit 342 and the sign extension unit 343 in the third embodiment, their description shall be omitted.

Next, the operation in the fourth embodiment shall be described.

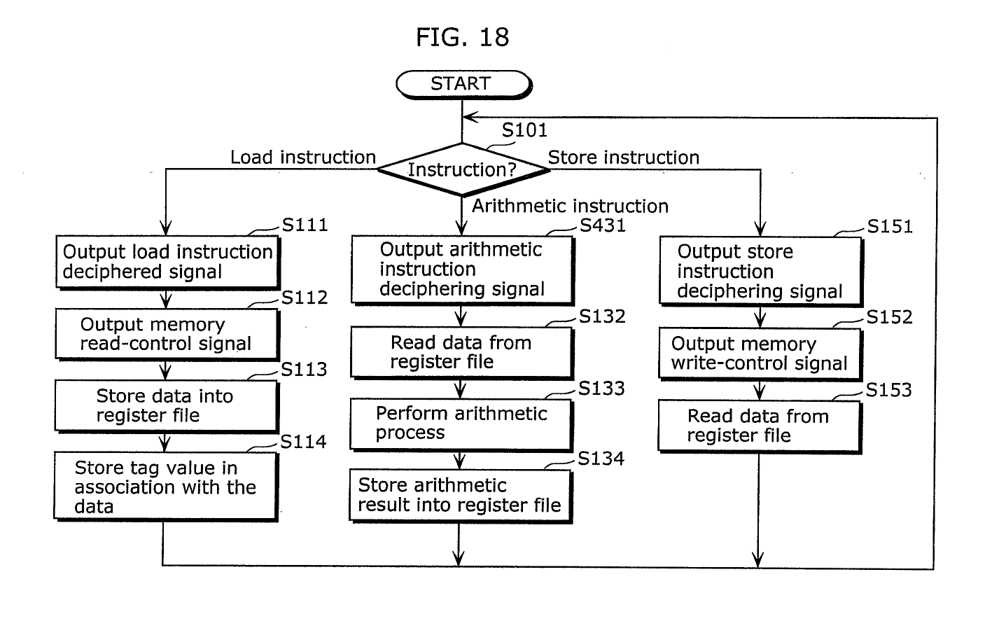

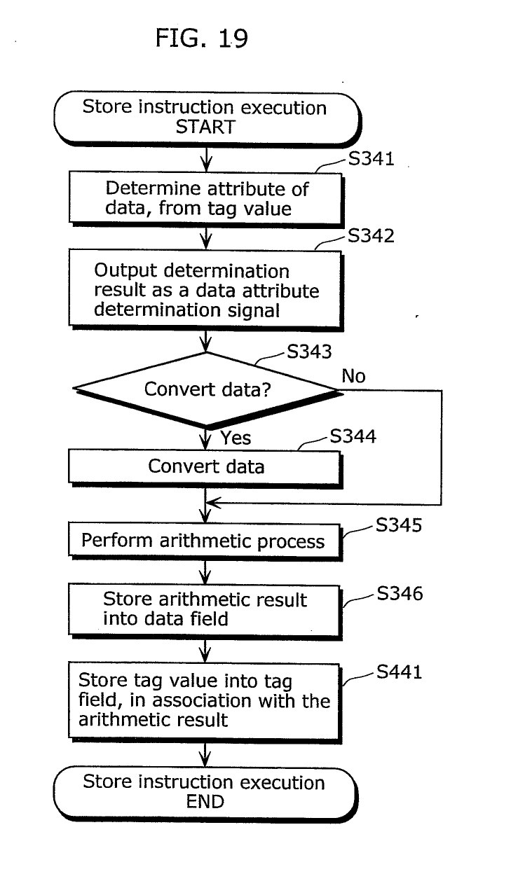

FIG. 18 and FIG. 19 are diagrams showing the operation of the processor in the fourth embodiment.

As shown in FIG. 18 and FIG. 19, a processor 400 is different, compared to the processor 300 in the third embodiment, with respect to the following point (2).

(1) Since the operation during the execution of a load instruction is the same as the operation (steps S111 to S114, and S121 to S122) in the third embodiment, description shall be omitted.

(2) The operation during the execution of an arithmetic instruction is different, compared to the operation (S131 to S135, and S341 to S346) in the third embodiment, in terms of the following points (see FIG. 7, FIG. 15A, FIG. 18, and FIG. 19).

In the case where the deciphered instruction is an arithmetic instruction, the instruction deciphering circuit 401 outputs an arithmetic instruction deciphered signal to the arithmetic unit 420 (step S431), in place of the operation (step S131) of the instruction deciphering circuit 101 in the third embodiment.

Furthermore, in the arithmetic unit 420, in place of the operation (step S135) of the tag value generation circuit 102 in the third embodiment, the data attribute determination circuit 421 stores, in a tag field 411 of the register file 410, the tag value indicating the attributes of the data to be stored in the register file 410 in accordance with the arithmetic instruction deciphered signal, in association with such data.

(3) Since the operation during the execution of a store instruction is the same as the operation (step S151 to S153, and S361 to S365) in the third embodiment, description shall be omitted.

As described thus far, according to the processor 400 in the fourth embodiment, tag fields 411 and data fields 412 are included in the register file 410, the data attribute determination circuit 421 and the arithmetic processing circuit 422 are included in the arithmetic unit 420, and the data attribute determination circuit 431 and the data conversion circuit 432 are included in the memory write-control unit 430.

Accordingly, since data conversion such as bit shifting, sign extension, and zero extension, can be performed within the arithmetic unit 420 and the memory write-control circuit 330, instead of between the memory 14 and the register file 410, it becomes possible to reduce the delay occurring between the memory 14 and the register file 410. Furthermore, since data obtained through the performance of an arithmetic process is affixed with a tag value indicating the attributes of such data, there is no need to specify the attributes of data for an instruction for the performance of an arithmetic process, and thus, it becomes possible to reduce the number of instructions and realize the simplification of the instruction deciphering circuit 401.

### Fifth Embodiment

Next, the fifth embodiment of the present invention shall be described with reference to the diagrams.

In the processor in the fifth embodiment, data which is larger than the size of a data field, is stored across plural registers. In addition, the processor is characterized in reconstructing the data from the data stored across the plural registers, and performing an arithmetic process on the reconstructed data.

On that basis, the processor in the fifth embodiment shall be described.

Note that constituent elements that are the same as in the third embodiment are given the same reference numbers and their description shall be omitted.

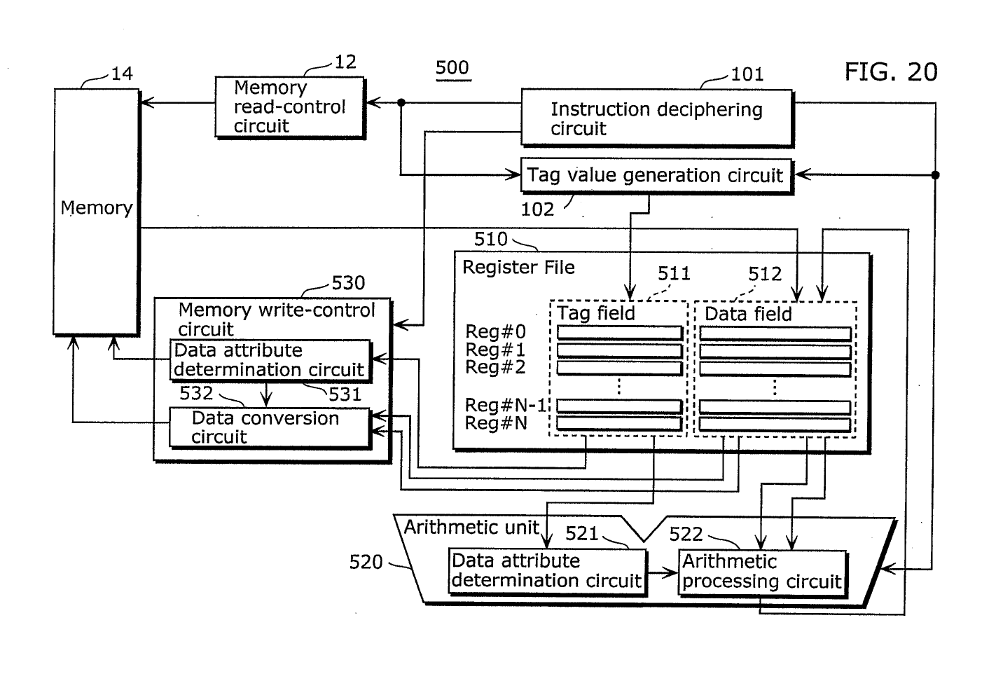

FIG. 20 is a diagram showing the configuration of the processor in the fifth embodiment.

As shown in the diagram, a processor 500 is different, compared to the processor 300 in the third embodiment, with respect to the following points (1) to (3) (see FIG. 5).

(1) The processor 500 includes a register file 510 in place of the register file 310.

The register file 510 is different, compared to the register file 310, in that, in the case of storing data which is larger than the size of a data field 512, such data is stored across plural registers.

(2) The processor 500 includes an arithmetic unit 520 in place of the arithmetic unit 320.

The arithmetic unit 520 is different, compared to the arithmetic unit 320, in including a data attribute determination circuit 521 and an arithmetic processing circuit 522, in place of the data attribute determination circuit 321 and the arithmetic processing circuit 322.

The data attribute determination circuit 521 reads, from the register file 510, the tag value associated with the data identified by an arithmetic instruction deciphered signal, and determines the attributes of such data based on the read tag value. Subsequently, the data attribute determination circuit 521 outputs the determination result, as a data attribute determination signal, to the arithmetic processing circuit 522. In addition, the data attribute determination circuit 521 generates a tag value which indicates attributes of the data obtained through the performance of the arithmetic process identified by the arithmetic instruction deciphered signal, and stores the generated tag value into the register file, in association with the data obtained through the performance of the arithmetic process.

The arithmetic processing circuit 522 reads, from the register file 510, the data identified by the arithmetic instruction deciphered signal, and determines whether or not to convert the read data based on the data attribute determination signal. In the case where conversion is to be performed as a result of the determination, the read data is converted based on the data attribute determination signal. The arithmetic process identified by the arithmetic instruction deciphered signal is performed on the converted data. Then, the data obtained through the performance of the arithmetic process is stored in the register file.

Note that, in the case where conversion is not to be performed, the arithmetic process is performed directly without the read data being converted.

Moreover, in the case where data is stored across plural registers in the register file, the arithmetic processing circuit 522 reconstructs the data from the data read from such plural registers, and performs the arithmetic process identified by the arithmetic instruction deciphered signal on the reconstructed data. Then, the data obtained through the performance of the arithmetic process is stored across plural registers in the register file 510.

(3) The processor 500 includes a memory write-control circuit 530 in place of the memory write-control circuit 330.

The memory write-control circuit 530 is different, compared to the memory write-control circuit 330, in including a data attribute determination circuit 531 and a data conversion circuit 532, in place of the data attribute determination circuit 331 and the data conversion circuit 332.

The data attribute determination circuit 531 reads, from the register file 510, the tag value associated with the data identified by a store instruction deciphered signal, and determines the attributes of such data based on the read tag value. Subsequently, the data attribute determination circuit 531 outputs the determination result, as a data attribute determination signal, to the data conversion circuit 530. In addition, the data attribute determination circuit 531 outputs, to the memory, a memory write-control signal which is in accordance with the store instruction deciphered signal and the tag value.

The data conversion circuit 532 reads, from the register file 510, the data identified by the store instruction deciphered signal, and determines whether or not to convert the read data based on the data attribute determination signal. In the case where conversion is to be performed as a result of the determination, the read data is converted based on the data attribute determination signal, and the converted data is outputted to the memory.

In the case where conversion is not to be performed, the read data is stored directly to the memory 14 without being converted.

Note that, in the case where data is stored across plural registers in the register file 510, the data conversion circuit 532 reconstructs the data from the data read from such plural registers, and outputs the reconstructed data to the memory 14.

Next, the configuration of the arithmetic unit in the fifth embodiment shall be discussed as an example.

Here, the case where an adding process is performed on data which is stored across register (Reg#0) and register (Reg#1), and the data obtained through the performance of the adding process, in other words the adding result, is divided and stored in register (Reg#2) and register (Reg#3) is described as an example.

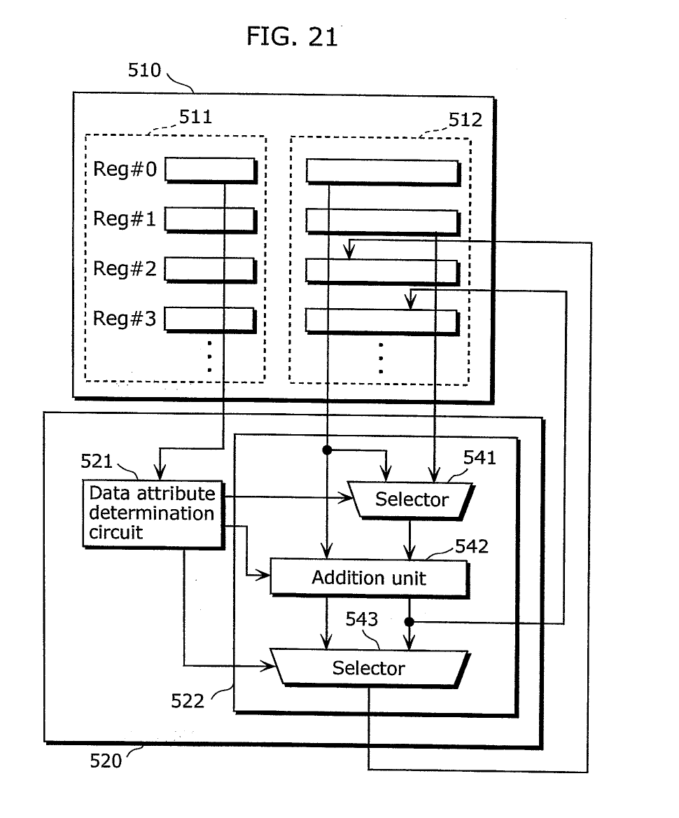

FIG. 21 is a diagram showing, as an example, the configuration of the arithmetic unit in the fifth embodiment.

As shown in the diagram, the data attribute determination circuit 521 reads the tag value from the tag field 511 of the register (Reg#0), and determines, based on the read tag value, that the data associated with the read tag value is the data stored across the register (Reg#0) and the register (Reg#1). Then, the data attribute determination circuit 521 outputs a data attribute determination signal, which indicates that the data is data stored across the register (Reg#0) and the register (Reg#1), to a selector 541, an addition unit 542, a selector 543 and so on.

Correspondingly, the selector 541 selects the data outputted from the data field 512 of the register (Reg#1), from between the data outputted from the data field 512 of the register (Reg#0) and the data outputted from the data field 512 of the register (Reg#1), and outputs the selected data to the addition unit 542.

In addition, with the data outputted from the data field 512 of the register (Reg#0) as a high portion and the data outputted from the selector 541, in other words the data outputted from the data field 512 of the register (Reg#1), as a low portion, the addition unit 542 reconstructs the data by combining the high portion and the low portion. Then, an adding process is performed on the reconstructed data, and the data obtained through the performance of the adding process, in other words the adding result, is divided into a high portion and a low portion which are respectively outputted to the selector 543. Furthermore, the low portion is stored in the data field of the register (Reg#3).

Then, the selector 543 selects the high portion, from between the high portion and the low portion outputted from the addition unit 542, and stores the high portion in the data field 512 of the register (Reg#2).

Next, the data structure in a register in the fifth embodiment shall be discussed as an example.

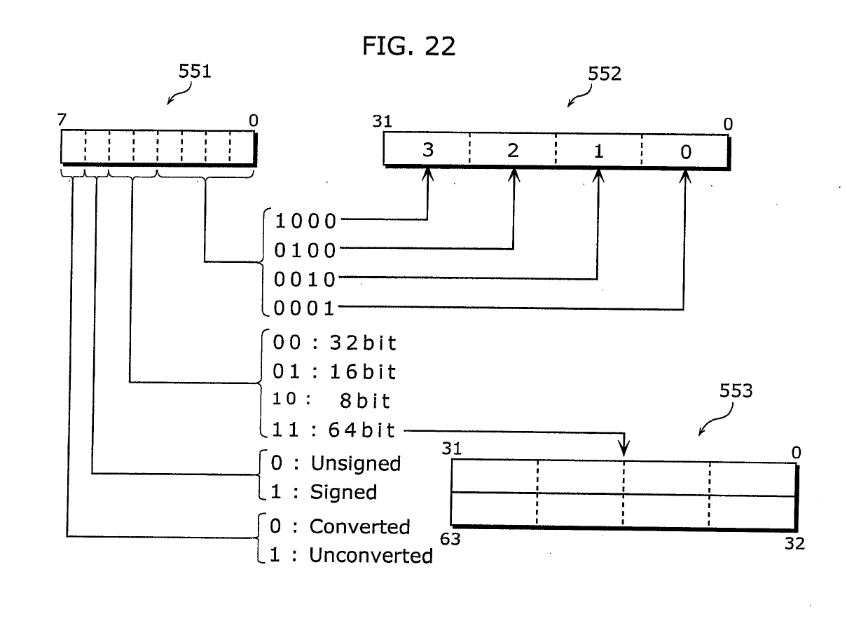

FIG. 22 is a diagram showing, as an example, the data structure in a register in the fifth embodiment.

As shown in the diagram, the register in the fifth embodiment is different, compared to the register in the first embodiment, in terms of the following point (2).

(1) Since the 4 lowest bits, from the 0^{th} bit to the 3^{rd} bit, of tag field 551 are the same as the 4 lowest bits, from the 0^{th} bit to the 3^{rd} bit, of tag field 151, description shall be omitted.

The two bits, from the 4th bit to the 5th bit, of the tag field 551 are different, compared with the two bits, from the 4th bit to the 5th bit, of the tag field 151, in that 64 bits is indicated in the case of (d) “11”. In this case, the size of a data field remains at 32 bits, and data field 553 of plural registers are assigned.

(3) Since the 2 bits, from the 6^{th} bit to the 7^{th} bit, of the tag field 551 are the same as the 2 bits, from the 6^{th} bit to the 7^{th} bit, of tag field 151, description shall be omitted.

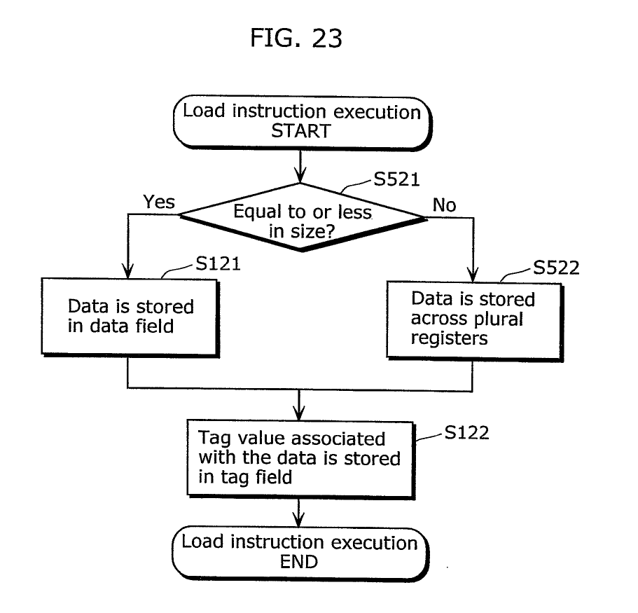

Next, the operation of the processor in the fifth embodiment shall be explained. FIG. 23 to FIG. 25 are diagrams showing the operation of the processor in the fifth embodiment.

As shown in FIG. 23 to FIG. 25, a processor 500 is different, compared to the processor 300 in the third embodiment, with respect to the following points (1) to (3).

(1) With regard to the operation during the execution of a load instruction, the following points are different compared to the operation (step S111 to S114, and S121 to S122) in the third embodiment (see FIG. 8A and FIG. 23).

In the register file 510, in case where the data identified by a memory read-control signal is larger than the size of a data field (No in step S521), such data is stored across plural registers (step S522).

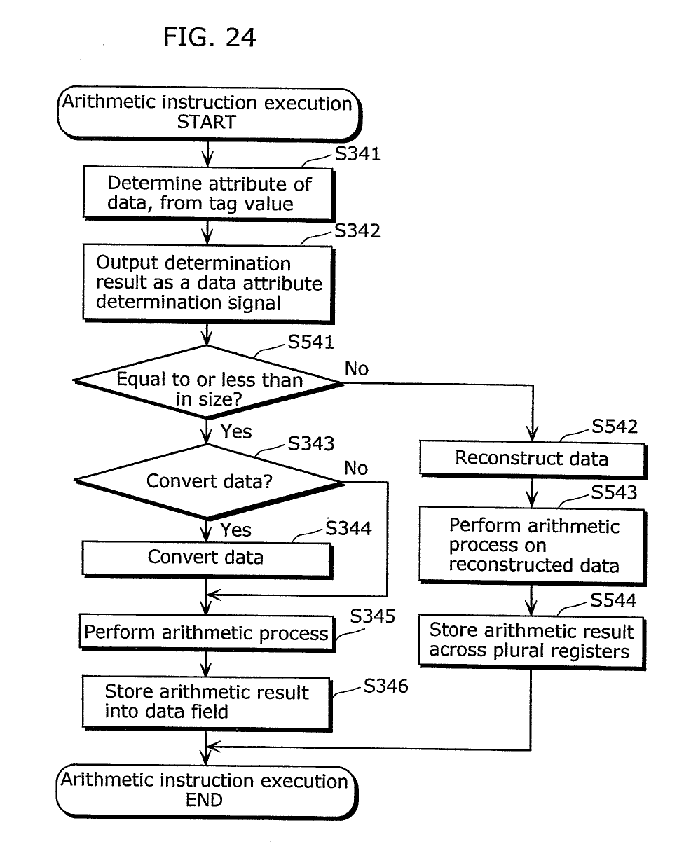

(2) The operation during the execution of an arithmetic instruction is different, compared to the operation (S131 to S135, and S341 to S346) in the third embodiment, in terms of the following points (see FIG. 15A and FIG. 24).

In the case where data identified by the arithmetic instruction deciphered signal is stored across plural registers (No in step 541), the arithmetic unit 520 reconstructs the data from the data read from such plural registers (step S542), and performs the arithmetic process on the reconstructed data (step 543). The data obtained through the performance of the arithmetic process is stored across plural registers in the register file 510 (step S544).

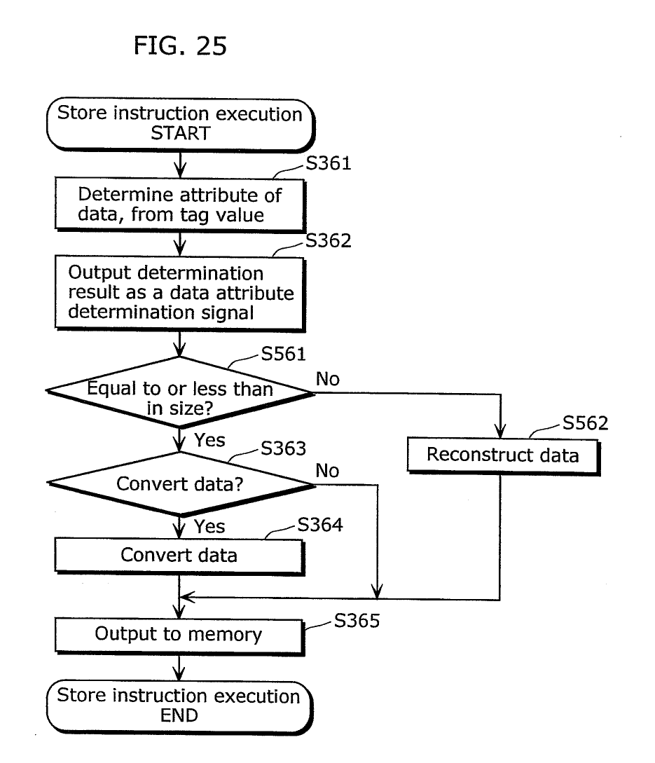

(3) With regard to the operation during the execution of a store instruction, the following points are different compared to the operation (steps S151 to S153, and S361 to S365) in the third embodiment (see FIG. 15A and FIG. 25).

In the case where the data identified by a memory write-control signal is stored across plural registers (No in step S561), the memory write-control circuit 530 reconstructs such data from the data read from such plural registers (step S562), and outputs the reconstructed data to the memory 14 (step S365).

As described thus far, according to the processor 500 in the fifth embodiment, tag fields 511 and data fields 512 are included in the register file 510, the data attribute determination circuit 521 and the arithmetic processing circuit 522 are included in the arithmetic unit 520, and the data attribute determination circuit 531 and the data conversion circuit 532 are included in the memory write-control unit 530.

With this, data which is larger than the size of a data field 512 can easily be handled.

### Sixth Embodiment

Next, the sixth embodiment of the present invention shall be described with reference to the diagrams.

In the processor in the sixth embodiment, data which is larger than the size of a data field is stored across plural registers. In addition, the processor is characterized in reconstructing data from the data stored across the plural registers, and performing an arithmetic process on the reconstructed data.

On that basis, the processor in the sixth embodiment shall be described.

Note that constituent elements that are the same as in the fifth embodiment are given the same reference numbers and their description shall be omitted.

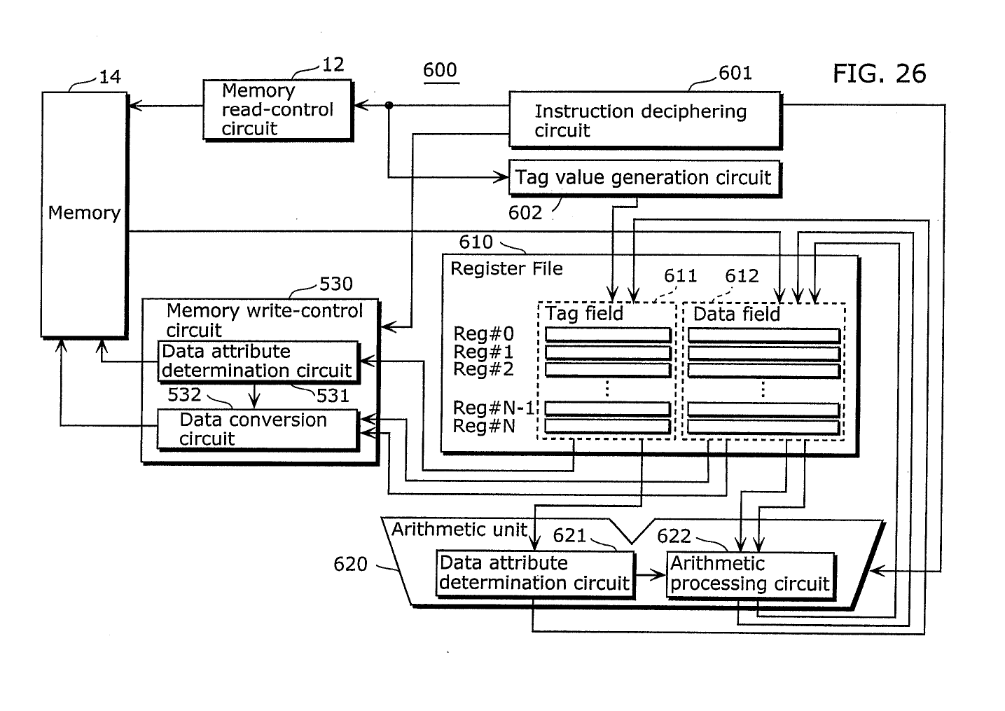

FIG. 26 is a diagram showing the configuration of the processor in the sixth embodiment.

As shown in the diagram, a processor 600 is different, compared to the processor 500 in the fifth embodiment, with respect to the following points (1) to (3) (see FIG. 7).

(1) The processor 600 includes an instruction deciphering circuit 601 in place of the instruction deciphering circuit 101.

The instruction deciphering unit 601 is different, compared to the instruction deciphering circuit 101, in terms of not outputting an arithmetic instruction deciphered signal to a tag value generation circuit 602 when executing an arithmetic instruction.

(2) The processor 600 includes the tag value generation circuit 602 in place of the tag value generation circuit 102. The tag value generation circuit 602 is different, compared to the tag value generation circuit 102, in terms of not generating a tag value indicating the attributes of data obtained through the performance of the arithmetic process identified by an arithmetic instruction deciphered signal.

(3) The processor 600 includes an arithmetic unit 620 in place of the arithmetic unit 520.

The arithmetic unit 620 is different, compared to the arithmetic unit 520, in including a data attribute determination circuit 621 and an arithmetic processing circuit 622, in place of the data attribute determination circuit 521 and the arithmetic processing circuit 522.

The data attribute determination circuit 621 reads, from a register file 610, the tag value associated with the data identified by an arithmetic instruction deciphered signal, and determines the attributes of such data based on the read tag value. Subsequently, the data attribute determination circuit 621 outputs the determination result, as a data attribute determination signal, to the arithmetic processing circuit 622. In addition, the data attribute determination circuit 621 generates a tag value which indicates attributes of the data obtained through the performance of the arithmetic process identified by the arithmetic instruction deciphered signal, and stores the generated tag value into the register file 610, in association with the data obtained through the performance of the arithmetic process.

The arithmetic processing circuit 622 reads, from the register file 610, the data identified by the arithmetic instruction deciphered signal, and determines whether or not to convert the read data based on the data attribute determination signal. In the case where conversion is to be performed as a result of the determination, the read data is converted based on the data attribute determination signal, and the arithmetic process identified by the arithmetic instruction deciphered signal is performed on the converted data. Then, the data obtained through the performance of the arithmetic process is stored in the register file 610.

Note that, in the case where conversion is not to be performed, the arithmetic process is performed directly without the read data being converted.

Moreover, in the case where data is stored across plural registers in the register file 610, the arithmetic processing circuit 622 reconstructs data from the data read from such plural registers, and performs the arithmetic process identified by the arithmetic instruction deciphered signal on the reconstructed data. Then, the data obtained through the performance of the arithmetic process is stored across plural registers in the register file 610.

Next, the configuration of the arithmetic unit in the sixth embodiment shall be discussed as an example.

Here, the case where an adding process is performed on data which is stored across register (Reg#0) and register (Reg#1), and the data obtained through the performance of the adding process, in other words the adding result, is divided and stored in register (Reg#2) and register (Reg#3) is described as an example.

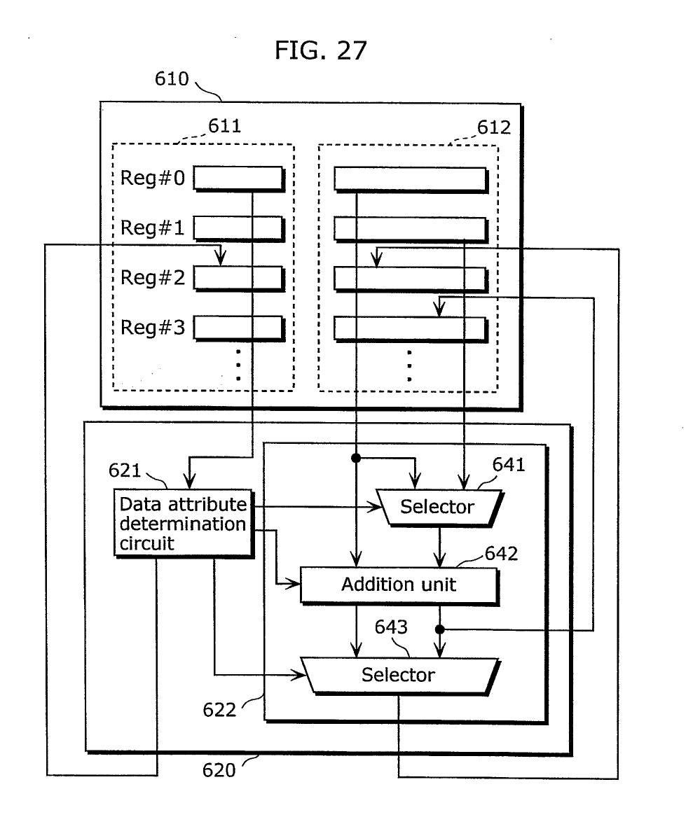

FIG. 27 is a diagram showing, as an example, the configuration of the arithmetic unit in the sixth embodiment.

As shown in the diagram, the data attribute determination circuit 621 reads the tag value from the tag field 611 of the register (Reg#0), and determines, based on the read tag value, that the data associated with the read tag value is the data stored across the register (Reg#0) and the register (Reg#1). Then, the data attribute determination circuit 621 outputs, to a selector 641, an addition unit 642, a selector 643 and so on, a data attribute determination signal which indicates that the data is data stored across the register (Reg#0) and the register (Reg#1).

Correspondingly, the selector 641 selects the data outputted from the data field 612 of the register (Reg#1), from between the data outputted from the data field 612 of the register (Reg#0) and the data outputted from the data field 612 of the register (Reg#1), and outputs the selected data to the addition unit 642.

In addition, with the data outputted from the data field 612 of the register (Reg#0) as a high portion and the data outputted from the selector 641, in other words the data outputted from the data field 612 of the register (Reg#1), as a low portion, the addition unit 642 reconstructs the data by combining the high portion and the low portion. Then, an adding process is performed on the reconstructed data, and the data obtained through the performance of the adding process, in other words the adding result, is divided into a high portion and a low portion which are respectively outputted to the selector 643. Furthermore, the low portion is stored in the data field of the register (Reg#3).

Then, the selector 643 selects the high portion, from between the high portion and the low portion outputted from the addition unit 642, and stores the high portion in the data field 612 of the register (Reg#2).

In addition, the data attribute determination circuit 621 generates a tag value for the result of the adding by the addition unit 642, in other words a tag value which indicates that the data is data stored across the register (Reg#2) and the register (Reg#3), and stores the generated tag value into the tag field 611 of the register (Reg#2).

Next, the operation of the processor 600 in the sixth embodiment shall be described.

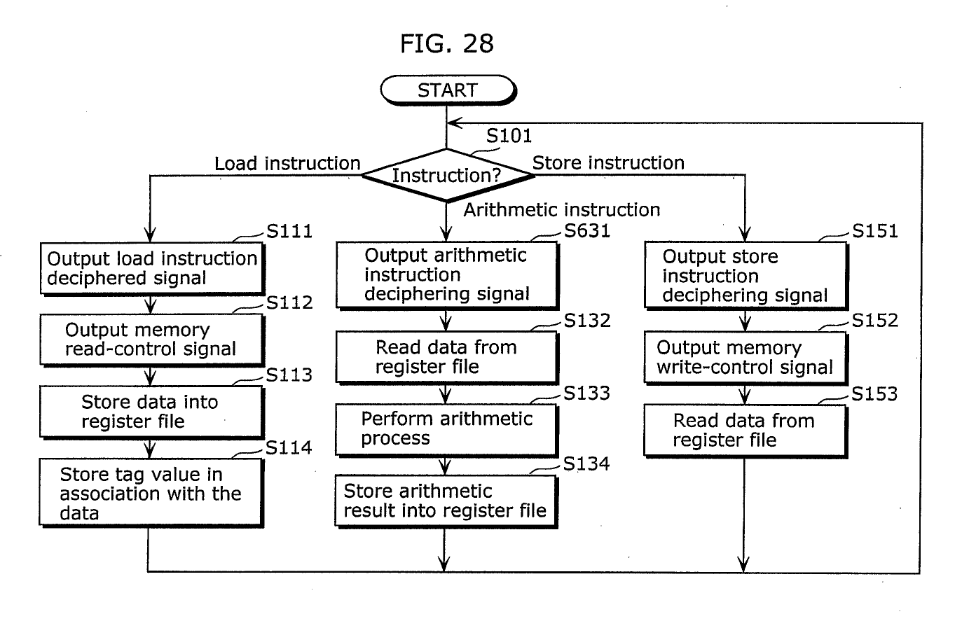

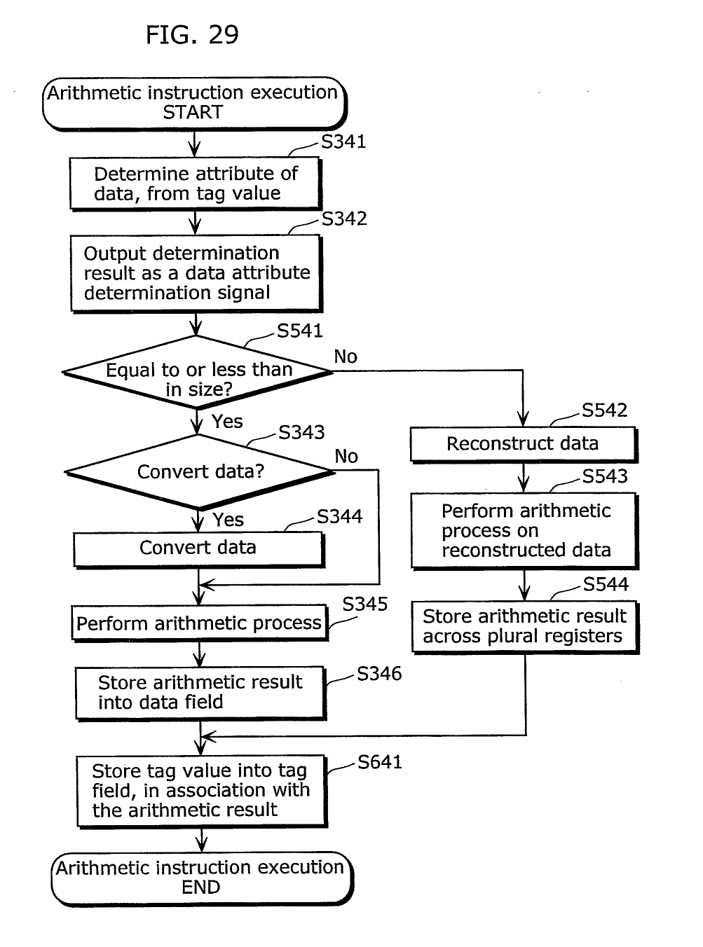

FIG. 28 and FIG. 29 are diagrams showing the operation of the processor in the sixth embodiment.

As shown in FIG. 28 and FIG. 29, a processor 600 is different, compared to the processor 500 in the fifth embodiment, with respect to the following point (2).

(1) Since the operation during the execution of a load instruction is the same as the operation (steps S111 to S114, S121 to S122, and S521 to S522) in the fifth embodiment, description shall be omitted.

(2) The operation during the execution of an arithmetic instruction is different, compared to the operation (steps S131 to S135, S341 to S346, and S541 to S544) in the fifth embodiment, in terms of the following points (see FIG. 7, FIG. 24, FIG. 28, and FIG. 29).

In the case where the deciphered instruction is an arithmetic instruction, the instruction deciphering circuit 601 outputs an arithmetic instruction deciphered signal to the arithmetic unit 620 (step S631), in place of the operation (step S131) of the instruction deciphering circuit 101 in the fifth embodiment.

Furthermore, in the arithmetic unit 620, in place of the operation (step S135) of the tag value generation circuit 102 in the fifth embodiment, the data attribute determination circuit 621 stores, into a tag field 611 of the register file 610, the tag value indicating the attributes of the data obtained through the performance of the arithmetic process, in association with such data (step S641).

(3) Since the operation during the execution of a store instruction is the same as the operation (steps S151 to 153, S361 to S365, and S561 to S562) in the fifth embodiment, description shall be omitted.

As described thus far, according to the processor 600 in the sixth embodiment, tag fields 611 and data fields 612 are included in the register file 610, the data attribute determination circuit 621 and the arithmetic processing circuit 622 are included in the arithmetic unit 620, and the data attribute determination circuit 531 and the data conversion circuit 532 are included in the memory write-control unit 530.

Accordingly, data which is larger than the size of the data field can easily be handled. Furthermore, since data obtained through the performance of an arithmetic process is affixed with a tag value indicating the attributes of such data, there is no need to specify the attributes of data for an instruction for the performance of an arithmetic process, and thus, it becomes possible to reduce the number of instructions and realize the simplification of the instruction deciphering circuit.

(Others)

Note that, in the case where data read from the memory is stored across plural registers, the tag value generation circuit may also generate a tag value including the number of registers across which such data is stored, in other words the number into which the data is divided, and store such tag value in the tag field.

Moreover, the processor may also be implemented using a full-custom Large Scale Integration (LSI). Furthermore, implementation using a semi-custom LSI such as an Application Specific Integrated Circuit (ASIC) is also possible. Furthermore, implementation using a programmable logic device such as a Field Programmable Gate Array (FPGA) and a Complex Programmable Logic Device (CPLD) is also possible. Furthermore, implementation using a dynamic reconfigurable device which allows dynamic circuit configuration rewriting is also possible.

In addition, the design data for formulating one or more of the functions, which make up the processor, in their respective LSIs may be a program written using a hardware description language such as Very high speed integrated circuit Hardware Description Language (VHDL), Verilog-HDL, and System C. Furthermore, it may also be a gate level net list obtained from the logical synthesis of HDL programs. Furthermore, it may also be macrocell which affixes placement information, process conditions, and the like, onto a gate level net list. Furthermore, the design data may also be mask data which prescribes size, timing, and so on.

In addition, to allow reading by a hardware system such as a computer system and an embedded system, the design data may be recorded in a computer readable recording medium such as an optical recording medium (for example, a CD-ROM and so on), a magnetic recording medium (for example, a hard disk and so on), a magneto-optical recording medium (for example, an MO and so on), and a semiconductor memory (for example, a RAM and so on). Moreover, design data which is read by an other hardware system via a recording medium may also be downloaded onto a programmable logic device via a download cable.

Alternatively, in order to allow an other hardware system to obtain the design data via a transmission channel such as a network, the design data may be held in a hardware system on the transmission channel. In addition, design data obtained, from a hardware system, by an other hardware system, via a transmission channel, may be downloaded onto a programmable logic device via a download cable.

Alternatively, design data that is logically synthesized, arranged, and wired may be recorded on a serial ROM in order to allow transmission to an FPGA upon the application of electric power. Moreover, the design data recorded in the serial ROM may also be downloaded directly onto the FPGA upon the application of electric power.

### INDUSTRIAL APPLICABILITY

The present invention can be used as a processor or the like which processes data, and particularly as a processor or the like which performs media processing, such as audio and video processing, which requires high-speed and large-volume arithmetic processing.

1. A processor comprising:
a register file having plural registers; and
a generation unit operable to generate a tag value which indicates a data attribute,
wherein each of the registers has a data field which holds data, and a tag field which holds the tag value, and
said generation unit is operable, when executing a load instruction for loading data from a memory to a register, to generate the tag value based on the load instruction, and to store the generated tag value into the tag field of the register.

2. The processor according to claim 1,
wherein the data field holds, as-is, the data outputted from the memory according to the execution of the load instruction for loading the data from the memory to the register.

3. The processor according to claim 2,
wherein said generation unit is operable to generate the tag value based on an address, a data size, and a data type specified in the load instruction, and
the data type indicates whether data to be transmitted is signed data or non-signed data.

4. The processor according to claim 3, further comprising
a conversion unit operable to perform conversion on the data held in the data field of the register, in accordance with the tag value.

5. The processor according to claim 4,
wherein said conversion unit is operable to perform zero extension or sign extension on the data held in the data field of the register, in accordance with the tag value.

6. The processor according to claim 5,
wherein said conversion unit is operable to perform the conversion when executing an instruction for reading a register.

7. The processor according to claim 5,
wherein said conversion unit is operable to perform the conversion in an idle cycle in which data is not read from or written into the register according to an instruction, and to update the tag field and the data field according to a conversion result.

8. The processor according to claim 4,
wherein said conversion unit is operable to perform the conversion when executing a store instruction for storing the data held in the data field of the register into the memory.

9. The processor according to claim 8, further comprising
a write-processing unit operable to write the data converted by said conversion unit into the memory, through a writing process which is in accordance with the tag value.

10. The processor according to claim 2,
wherein said processor divides, when executing a load instruction for reading data that is larger than the size of a data field from the memory, to divide the data which is read from the memory, and to store the divided data into two or more of the data fields.

11. The processor according to claim 10,
wherein said generation unit is operable to store, into the tag field, a tag value which includes the number of divisions into which the data has been divided.

12. The processor according to claim 11, comprising
an arithmetic processing unit operable, when executing an arithmetic instruction for reading data stored in the data field of the register and performing an arithmetic process on the data, to reconstruct data by combining the data stored in two or more of the data fields in accordance with the number of divisions, and to perform the arithmetic process on the reconstructed data.

13. The processor according to claim 12,
wherein said arithmetic processing unit is further operable, in the case where an arithmetic processing result is larger than the size of a data field, to store the arithmetic processing result across two or more of the data fields, and to store, into a corresponding tag field, a tag value which indicates that the arithmetic processing result is stored across two or more of the data fields, the tag value being associated with the arithmetic processing result.

14. The processor according to claim 11,
wherein said processor divides, when executing a store instruction for writing data that is larger than the size of a data field into the memory, to reconstruct the data stored across two or more of the data fields, and to write the reconstructed data into the memory.
